(19) United States
(12) Patent Application Publication
(10) Pub. No.: US 2026/0032338 A1
(43) Pub. Date: Jan. 29, 2026

(54) MULTI-CHIP CAMERA CONTROLLER SYSTEM WITH INTER-CHIP COMMUNICATION THAT PERFORMS UNSYNCHRONIZED ON-DEMAND REMOTE SENSING

(71) Applicant: Cirrus Logic International Semiconductor Ltd., Edinburgh (GB)

(72) Inventors: Sachin Deo, Austin, TX (US); Nariankadu D. Hemkumar, Austin, TX (US); Franz Weller, Austin, TX (US); Nathan Daniel Pozniak Buchanan, Austin, TX (US)

(21) Appl. No.: 19/301,629

(22) Filed: Aug. 15, 2025

Related U.S. Application Data
(63) Continuation-in-part of application No. 18/916,181, filed on Oct. 15, 2024.
Application No. 18/916,181 is a continuation of application No. 17/737,673, filed on May 5, 2022, now Pat. No. 12,143,713.
Application No. 17/737,673 is a continuation of application No. 17/737,615, filed on May 5, 2022, now Pat. No. 11,979,659.
Application No. 17/737,615 is a continuation-in-part of application No. 17/320,528, filed on May 14, 2021, now Pat. No. 12,158,687.
(60) Provisional application No. 63/024,735, filed on May 14, 2020.
(60) Provisional application No. 63/186,022, filed on May 7, 2021.
(60) Provisional application No. 63/186,022, filed on May 7, 2021.
(60) Provisional application No. 63/186,022, filed on May 7, 2021.

(51) Int. Cl. H04N 23/661; G01D 5/14; G03B 13/36; H04N 23/60; H04N 23/66

(52) U.S. Cl. CPC H04N 23/661; G01D 5/145; G03B 13/36; H04N 23/66; H04N 23/662; H04N 23/665

(57) ABSTRACT

A system that controls a lens/image sensor position includes primary and secondary camera control devices (CCDs) and a communication link connecting them. The CCDs periodically sense respective primary and secondary position sensors to obtain respective primary and secondary position samples. The primary prepares a demand for secondary position sensor information and transmits the demand to the secondary. The secondary produces the secondary position sensor information by decimating secondary position samples that are youngest with respect to the demand and transmits the secondary position sensor information to the primary. The primary produces primary position sensor information by decimating primary position samples and generates control data by processing the primary and secondary position sensor information. The primary prepares the demand at a predetermined time offset from a start of a current control loop period such that the secondary position sensor information is received by the primary within the current control loop period.

### CROSS REFERENCE TO RELATED APPLICATION(S)

This application is a continuation-in-part of U.S. Non-Provisional application Ser. No. 18/916,181 (P4065US02), filed Oct. 15, 2024, which is a continuation of U.S. Non-Provisional application Ser. No. 17/737,673 (P4065US01), filed May 5, 2022, which is a continuation of U.S. Non-Provisional application Ser. No. 17/737,615 (P4065US00), filed May 5, 2022, which is a continuation-in-part of U.S. Non-Provisional application Ser. No. 17/320,528 (P3880US00), filed May 14, 2021, which claims priority based on U.S. Provisional Application, Ser. No. 63/024,735 (P3880USPROV), filed May 14, 2020 and claims priority based on U.S. Provisional Application Ser. No. 63/186,022 (P4065USPROV), filed May 7, 2021, and application Ser. No. 17/737,673 (P4065US01) and application Ser. No. 17/737,615 (P4065US00) claim priority based on U.S. Provisional Application Ser. No. 63/186,022 (P4065USPROV), and each of the above Applications is hereby incorporated by reference in its entirety.

### BACKGROUND

Camera controllers are used to control and drive a camera (e.g., camera lenses and parts), and such controllers and cameras are used in applications such as smart phones, tablets, and computers. Such a controller or device needs to obtain and process data from the camera lenses and parts. The accurate and efficient delivery and management of data (e.g., datastreams and sub-streams) between the camera controllers and the camera are very important. An example of the delivery and management of such data is provided by U.S. patent application Ser. No. 16/522,580 entitled “FLEXIBLE LATENCY-MINIMIZED DELIVERY AND MANAGEMENT OF DISPARATE-RATE DATA STREAMS AND SUB-STREAMS FOR PROCESSING” filed on 25 Jul. 2018 to inventors James McFarland, Nariankadu Hemkumar, Sachin Deo, and Younes Djadi (hereafter referred to as the “580 Patent Application”), published as U.S. Patent Application Publication 2021/0029319 on Jan. 28, 2021. The 580 Patent Application is hereby incorporated by reference in its entirety.

### SUMMARY

In one embodiment, the present disclosure provides a system that controls the position of a lens/image sensor. The system includes a primary camera control device (CCD), a secondary CCD, and a communication link that connects the primary CCD and the secondary CCD. The primary and secondary CCDs periodically sense respective primary and secondary position sensors to obtain respective primary and secondary position samples. The primary CCD prepares a demand for secondary position sensor information from the secondary CCD and transmits the demand to the secondary CCD over the communication link. The secondary CCD produces the secondary position sensor information by decimating secondary position samples that are youngest with respect to the demand and transmits the secondary position sensor information to the primary CCD over the communication link. The primary CCD produces primary position sensor information by decimating primary position samples and generates control data by processing the primary and secondary position sensor information. The primary CCD prepares the demand at a predetermined time offset from a start of a current control loop period such that the secondary position sensor information is received by the primary CCD within the current control loop period.

In another embodiment, the present disclosure provides a method for operating a system that controls the position of a lens/image sensor, the system comprising a primary camera control device (CCD) and a secondary CCD connected by a communication link. The method includes periodically sensing, by the primary and secondary CCDs, respective primary and secondary position sensors to obtain respective primary and secondary position samples. The method further includes preparing, by the primary CCD, a demand for secondary position sensor information from the secondary CCD. The method further includes transmitting, by the primary CCD, the demand to the secondary CCD over the communication link. The method further includes producing, by the secondary CCD, the secondary position sensor information by decimating secondary position samples that are youngest with respect to the demand. The method further includes transmitting, by the secondary CCD, the secondary position sensor information to the primary CCD over the communication link. The method further includes producing, by the primary CCD, primary position sensor information by decimating primary position samples. The method further includes generating, by the primary CCD, control data by processing the primary and secondary position sensor information. The primary CCD prepares the demand at a predetermined time offset from a start of a current control loop period such that the secondary position sensor information is received by the primary CCD within the current control loop period.

Embodiments of the present disclosure describe a communication link connecting two or more devices in a camera controller system. The camera controller system includes two or more camera controller devices that receive sensor data from sensors and that control actuators, e.g., voice coil motors. The camera controller system also includes a communication link connecting the primary device to the secondary devices. The communication link may operate in half-duplex mode or full-duplex mode. A host processor is in communication with the camera controller system. A camera module may include the camera controller system, an image sensor, the actuators that position the image sensor, and the sensors that sense position data of the image sensor.

The communication link supports synchronous and time critical operation. The communication link may include a clockless interface that includes a single wire in a half-duplex configuration, or two wires in a full-duplex configuration. The communication link transfers voice coil motor (VCM) data and sensor data between the primary and secondary devices. The communication link transfers control and status information from the primary device to the secondary device. The communication link transfers sensor data and status information from the secondary device to the primary device. The communication link enables the primary device to access memories and registers of the secondary device. The communication link may detect a single bit error in idle and active modes. The data transfer on the communication link is triggered by the host processor in an open loop mode or by the device digital signal processor (DSP) frame in a closed loop mode. The communication link may be used to synchronize sensor data capture and VCM driver data application between the primary and secondary devices. On the transmit side, a flush byte (e.g., 0xFF) may be appended at the end of a packet to indicate to the receiver the completion of packet transmission. On the receive side, the receiver state machine resynchronizes upon detection of a parity error, which may happen when the flush byte is detected or if a bit flips due to an external noise source. The secondary device DSP frame may be synchronized to the primary device DSP frame.

Embodiments of the present disclosure may be extended to more than two devices.

In one embodiment, the present disclosure provides a system for using actuators to control an image sensor and/or lens based on sensor data received from position sensors and based on position information for the image sensor and/or lens received from a host processor. The system includes a primary camera controller device, at least one secondary camera controller device, and at least one communication link connecting the primary camera controller device and the at least one secondary camera controller device. The primary and secondary camera controller devices are configured to receive respective primary and secondary sensor data from the position sensors, send the respective primary and secondary sensor data to the other camera controller device via the communication link, process the primary and secondary sensor data and the position information to generate respective primary and secondary control data, and drive the respective primary and secondary control data to the actuators concurrently.

In another embodiment, the present disclosure provides a method for using actuators to control an image sensor and/or lens based on sensor data received from position sensors and based on position information for the image sensor and/or lens received from a host processor. The method includes receiving, a primary camera controller device and at least one secondary camera controller device, respective primary and secondary sensor data from the position sensors. The method also includes sending, by the primary camera controller device and the at least one secondary camera controller device, the respective primary and secondary sensor data to the other camera controller device via at least one communication link connecting the primary camera controller device and the at least one secondary camera controller device. The method also includes processing, by the primary camera controller device and the at least one secondary camera controller device, the primary and secondary sensor data and the position information to generate respective primary and secondary control data. The method also includes driving, by the primary camera controller device and the at least one secondary camera controller device, the respective primary and secondary control data to the actuators concurrently.

In another embodiment, the present disclosure provides a system for using actuators to position an image sensor and/or lens based on position data of the image sensor and/or lens sensed by position sensors includes a primary camera controller device comprising sensor inputs that receive first sensor data from the position sensors and control outputs that drive first control data to the actuators, at least one secondary camera controller device comprising sensor inputs that receive second sensor data from the position sensors and control outputs that drive second control data to the actuators, and at least one communication link connecting the primary camera controller device and the at least one secondary camera controller device. The secondary camera controller device sends the second sensor data to the primary camera controller device via the communication link. The primary camera controller device processes the first and second sensor data to generate the first control data.

In another embodiment, the present disclosure provides a method for using actuators to position an image sensor and/or lens based on position data of the image sensor and/or lens sensed by position sensors. The method includes, by a primary camera controller device: receiving, by sensor inputs, first sensor data from the position sensors, and driving, by control outputs, first control data to the actuators. The method also includes, by at least one secondary camera controller device: receiving, by sensor inputs, second sensor data from the position sensors, and driving, by control outputs, second control data to the actuators. The method also includes, sending, by the secondary camera controller device, the second sensor data to the primary camera controller device via at least one communication link connecting the primary camera controller device and the at least one secondary camera controller device. The method also includes, processing, by the primary camera controller device, the first and second sensor data to generate the first control data.

### BRIEF DESCRIPTION OF THE DRAWINGS

FIG. 1 is an example system of primary and secondary devices in communication with one another to provide an increased number of synchronized outputs in accordance with embodiments of the present disclosure.

FIG. 2 is an example firmware driver framework on the primary device and the secondary devices of FIG. 1 in accordance with embodiments of the present disclosure.

FIG. 3 is an example Universal Asynchronous Receiver Transmitter (UART) packet structure for transmission between the primary and secondary devices of FIG. 1 in accordance with embodiments of the present disclosure.

FIG. 4 is an example flowchart illustrating an UART Receive Interrupt Service Routine (ISR) process of the secondary device of FIG. 1 in accordance with embodiments of the present disclosure.

FIG. 5 is an example flowchart illustrating the handling of open-loop code on the primary device of FIG. 1 in an I2C ISR that services host processor commands for open-loop digital-to-analog converter (DAC) codes in accordance with embodiments of the present disclosure.

FIG. 6 is an example flowchart illustrating an UART Transmit ISR process of the primary device of FIG. 1 in accordance with embodiments of the present disclosure.

FIG. 7 is an example flowchart illustrating the handling by the primary device of FIG. 1 of transmission of a voice coil motor (VCM) code in event timer ISR in accordance with embodiments of the present disclosure.

FIGS. 8A and 8B, referred to collectively as FIG. 8, is an example timing diagram illustrating run-time execution flow for open-loop and closed-loop states of the system of FIG. 1 in accordance with embodiments of the present disclosure.

FIG. 9 is an example timing diagram illustrating operation of the system of FIG. 1 in accordance with embodiments of the present disclosure.

FIG. 10 is an example block diagram illustrating a system in accordance with embodiments of the present disclosure.

FIG. 11 is an example timing diagram illustrating operation in the first configuration in the closed loop mode in accordance with embodiments of the present disclosure.

FIG. 12 is an example timing diagram illustrating operation in the second configuration in the closed loop mode in accordance with embodiments of the present disclosure.

FIGS. 13A and 13B, referred to collectively as FIG. 13, is an example timing diagram illustrating operation in the third configuration in the closed loop mode in accordance with embodiments of the present disclosure.

FIG. 14 is an example block diagram illustrating use of a free running counter on the secondary device to accomplish secondary to primary DSP frame synchronization in accordance with embodiments of the present disclosure.

FIG. 15 is an example block diagram illustrating a system in a half-duplex configuration in accordance with embodiments of the present disclosure.

FIG. 16 is an example block diagram illustrating circuitry that performs UART TX pad disabling when bus contention or a chip error is detected in accordance with embodiments of the present disclosure.

FIG. 17 is an example block diagram illustrating a system in a full-duplex configuration in accordance with embodiments of the present disclosure.

FIG. 18 is example block diagram illustrating UART data bytes framed to include a start bit, seven data bits transmitted least significant bit (LSB) first, an odd parity bit, and a stop bit in accordance with embodiments of the present disclosure.

FIG. 19 is a primary device to secondary device packet structure used on the communication link starting with a header byte that specifies the type of packet in accordance with embodiments of the present disclosure.

FIG. 20 is an example block diagram of a VCM DAC data packet in accordance with embodiments of the present disclosure.

FIG. 21 is an example block diagram of a primary to secondary sensor data packet in accordance with embodiments of the present disclosure.

FIG. 22 is an example block diagram of a secondary to primary sensor data packet in accordance with embodiments of the present disclosure.

FIG. 23 is an example block diagram of a secondary status packet in accordance with embodiments of the present disclosure.

FIG. 24 is an example timing diagram illustrating communication between the primary device and the secondary device when the primary device transmits a VCM DAC data packet that does not request status in accordance with embodiments of the present disclosure.

FIG. 25 is an example timing diagram illustrating communication between the primary device and the secondary device when the primary device transmits a VCM DAC data packet that requests status in accordance with embodiments of the present disclosure.

FIG. 26 is an example block diagram illustrating an extended secondary status packet in accordance with embodiments of the present disclosure.

FIG. 27 is an example block diagram illustrating a primary to secondary command packet header in accordance with embodiments of the present disclosure.

FIG. 28 is an example block diagram illustrating a secondary to primary response packet header in accordance with embodiments of the present disclosure.

FIG. 29 is an example block diagram illustrating a primary to secondary 16-bit register read command packet in accordance with embodiments of the present disclosure.

FIG. 30 is an example block diagram illustrating a secondary response packet to a 16-bit register read command packet in accordance with embodiments of the present disclosure.

FIG. 31 is an example block diagram illustrating a primary to secondary 32-bit register read command packet in accordance with embodiments of the present disclosure.

FIG. 32 is an example block diagram illustrating a secondary response packet to a 32-bit register read command packet in accordance with embodiments of the present disclosure.

FIG. 33 is an example block diagram illustrating a primary to secondary 16-bit register write command packet in accordance with embodiments of the present disclosure.

FIG. 34 is an example block diagram illustrating an ACK packet to a 16-bit register write command packet in accordance with embodiments of the present disclosure.

FIG. 35 is an example block diagram illustrating a primary to secondary 32-bit register write command packet in accordance with embodiments of the present disclosure.

FIG. 36 is an example block diagram illustrating an ACK packet to a 32-bit register write command packet in accordance with embodiments of the present disclosure.

FIG. 37 is an example block diagram illustrating a system configured to perform unsynchronized on-demand remote sensing in accordance with embodiments of the present disclosure.

FIG. 38A is an example flowchart illustrating unsynchronized on-demand remote sensing by a system in accordance with a first embodiment of the present disclosure.

FIG. 38B is an example timing diagram illustrating unsynchronized on-demand remote sensing in accordance with the first embodiment of the present disclosure.

FIG. 39A is an example flowchart illustrating unsynchronized on-demand remote sensing by a system in accordance with a second embodiment of the present disclosure.

FIG. 39B is an example timing diagram illustrating unsynchronized on-demand remote sensing in accordance with the second embodiment of the present disclosure.

FIG. 40A is an example flowchart illustrating unsynchronized on-demand remote sensing by a system in accordance with a third embodiment of the present disclosure.

FIG. 40B is an example timing diagram illustrating unsynchronized on-demand remote sensing in accordance with the third embodiment of the present disclosure.

FIG. 41 is an example block diagram illustrating a system configured to perform unsynchronized on-demand remote sensing and remote actuation in accordance with the third embodiment of the present disclosure.

FIG. 42 is an example flowchart illustrating remote activation with respect to a system in accordance with the embodiments of the present disclosure.

FIG. 43 is an example flow diagram illustrating use of the ping-pong buffers in accordance with the first embodiment of the present disclosure.

FIG. 44 is an example flow diagram illustrating use of the ping-pong buffers in accordance with the second embodiment of the present disclosure.

FIG. 45 is an example block diagram of a secondary demand packet in accordance with the third embodiment of the present disclosure.

FIG. 46 is an example block diagram of a secondary position sensor information packet in accordance with the third embodiment of the present disclosure.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

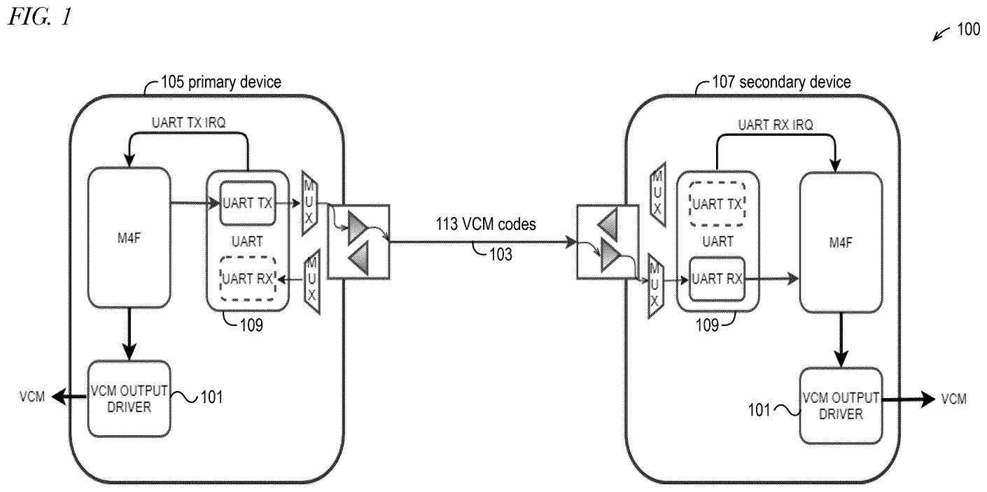

In certain camera control systems, there is a need to extend one or more voice coil motor (VCM) driver outputs using a secondary device 107 of FIG. 1 that operates in tandem and in tight synchronization with a primary device 105 of FIG. 1. A Universal Asynchronous Receiver/Transmitter (UART) and Event Timer based method and system are disclosed to achieve such synchronization. This method and system accommodate both major states of operation—open-loop mode and closed-loop mode.

A viable option for extending the VCM output driver channels beyond the number of supported channels on a single device, including but not limited to a camera controller, is to connect two devices (e.g., two camera controllers) in primary/secondary configuration communicating VCM codes 113 of FIG. 1 over UART 109 of FIG. 1. In general, the primary and secondary devices operate asynchronously with respect to each other. Therefore, it is not practical to have two devices configured and controlled for identical processing to achieve duplication of one or more VCM Driver outputs 101 of FIG. 1, while also ensuring tight synchronization of the same. In order to achieve tight synchronization and duplication, a method and system must be developed, whereby only the primary device does the processing (e.g., by processor M4F of FIG. 1), and the secondary device mirrors the desired output(s).

The primary/secondary output skew is defined to be the time duration between VCM code(s) application on the primary and secondary devices. The desire is to minimize the output skew between the primary device and the secondary device, as well as to minimize the VCM code application latency post processing on both the primary and secondary devices. In addition, it is highly desirable to have VCM code transmission (from the primary device) and reception (on the secondary device) to be non-blocking (neither entity is required to wait on the other for transmission and/or reception). Finally, the method and system should be efficient to minimally impact processing capabilities on the primary device and/or the secondary device.

The system 100 and method shown in FIG. 1 and in accordance with the present disclosure duplicates one VCM driver output 101 from the primary device 105 onto the secondary device 107. However, the system and method may also be used to duplicate all of the primary device's VCM driver outputs 101, constrained only by the speed of the UART communication link 103, excess processing capability, and time duration between computation of VCM codes 103 and the desired application latency on the VCM drivers 101.

The system and method below provide four (4) VCM outputs: two (2) OIS (Optical Image Stabilization)+one (1) AF (Auto-Focus) on the primary device, and one (1) AF on the secondary device. The AF VCM output driver on the secondary device duplicates AF VCM output driver on the primary device. The specific realization of the method described below allows for synchronized update of both the primary and secondary AF VCM driver outputs in both open-loop and closed-loop modes of operation with an output skew of less than 20 μs. The same system may also be devised to provide two (2) OIS VCM outputs on the primary device and two (2) AF VCM outputs on the secondary device. In general, many configurations are possible including swapping of OIS and AF VCM outputs on the primary and secondary devices as described above.

An example embodiment of the present disclosure is provided and organized in detail as follows: software framework, VCM Code packet structure to ensure basic minimum integrity, UART Transmit driver on the primary device, UART Receive driver on the secondary device and run-time execution context of UART communication in open-loop and closed-loop modes of operation and mode switching thereof.

### Software Framework

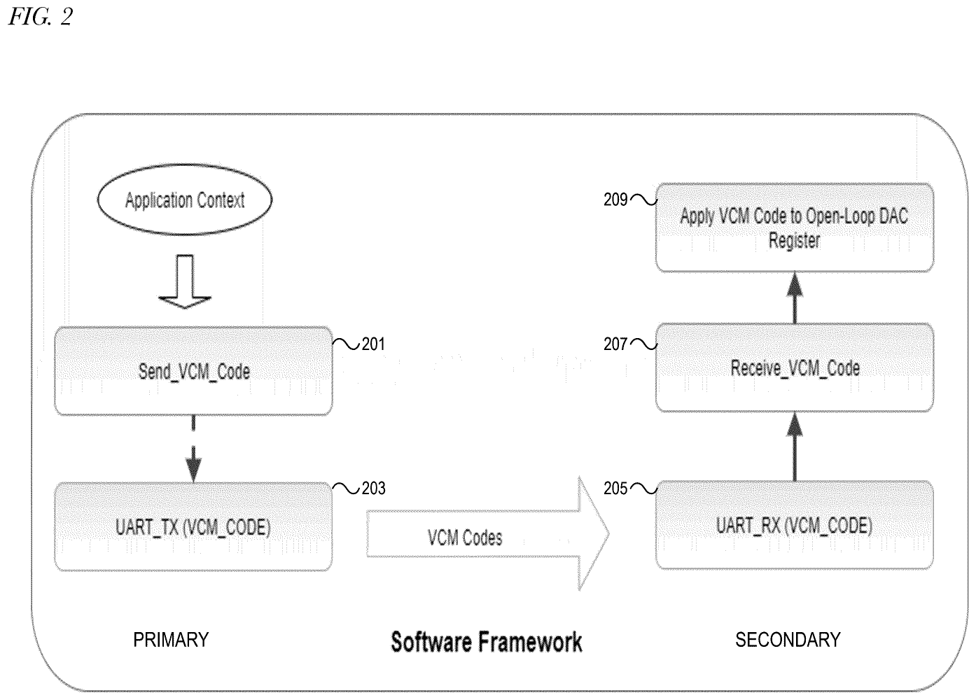

Firmware driver framework on the primary device and the secondary device is outlined in the diagram shown as FIG. 2. The primary device transmits VCM codes (blocks 201 and 203) in one of the two system states—closed-loop mode or open-loop mode over UART. The secondary device receives VCM codes (blocks 205 and 207) and applies them to the open-loop digital-to-analog converter (DAC) register (block 209). While the primary device may be in the open-loop mode or closed-loop mode of operation, the secondary device always operates in the open-loop mode.

### VCM Packet Structure

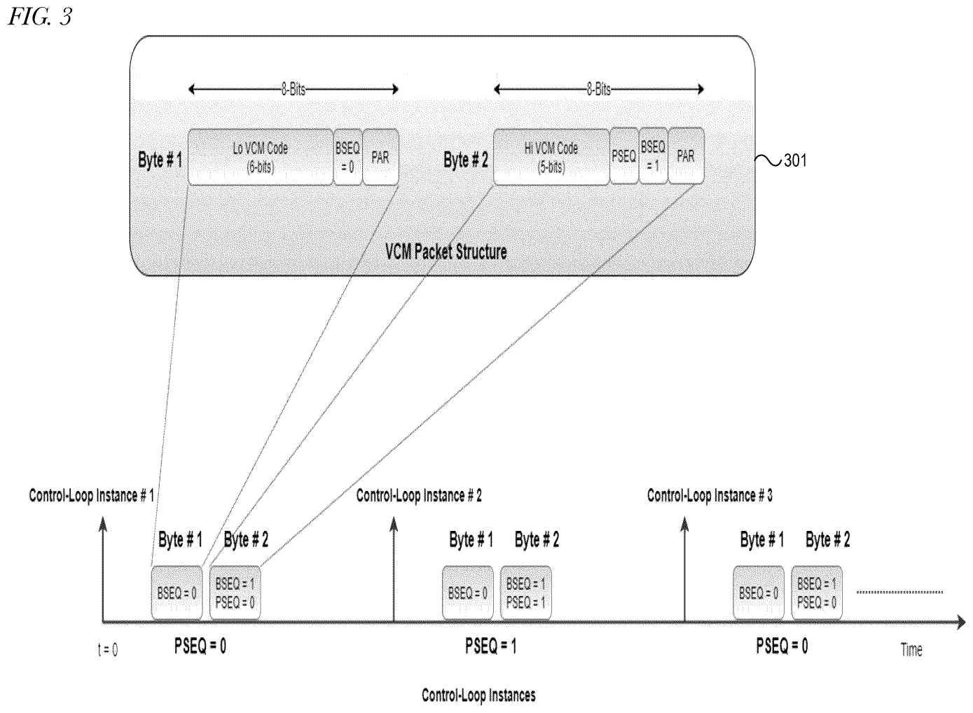

Each eleven (11)-bit AF VCM current DAC (IDAC) code is sent over a UART packet. A two (2)-byte packet structure 301 to ensure basic integrity of sequence, data, and packet is shown in FIG. 3. Parity bit (PAR) checks data integrity by indicating odd parity of bits, Byte sequence bit (BSEQ) identifies correct byte order within a packet, and the Packet sequence bit (PSEQ) identifies alternate (odd/even) packets as a check on the expected packet sequence versus received packet sequence.

### UART Receive Driver

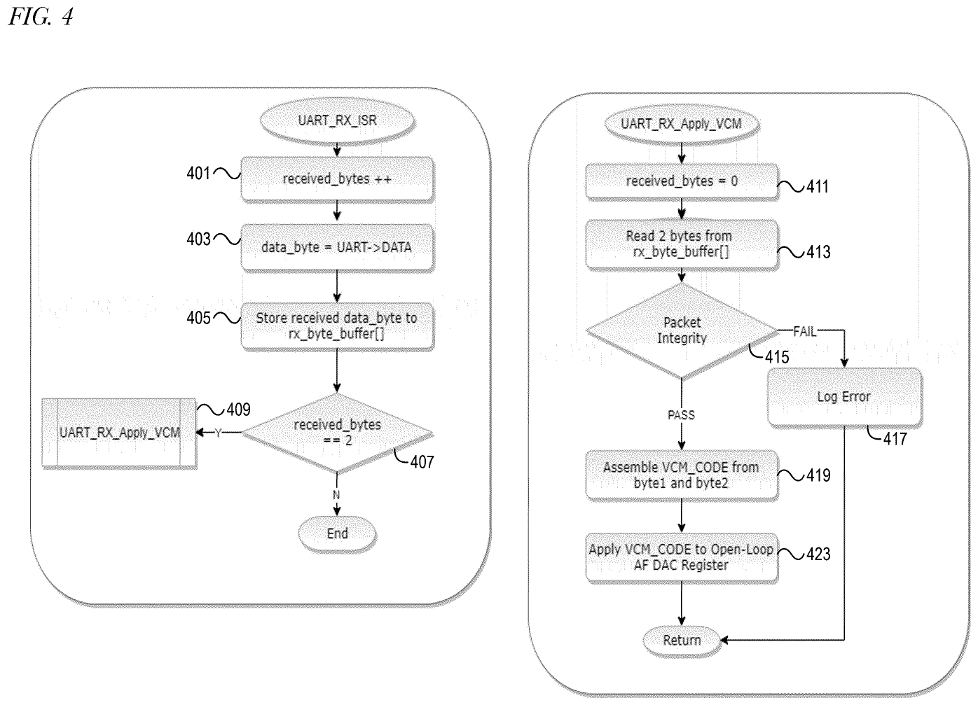

The application of VCM code on the secondary device is done entirely in UART Receive ISR (Interrupt Service Routine)—UART_RX_ISR—context. As soon as a complete VCM packet is received on the secondary device (blocks 401 through 407), VCM code is extracted from the packet after it passes a basic integrity check (blocks 411 through 417). The extracted VCM code is applied to the open-loop DAC register on the secondary device for immediate effect (block 409 and blocks 419 and 423). This process on the secondary device is shown in the flow-chart of FIG. 4.

### UART Transmit Driver

Unlike the secondary device, which applies the VCM code immediately upon receipt, the primary device precisely times the application of the VCM code to coordinate the timing of the application and keeps the primary/secondary skew to a minimum. The handling of the VCM code on the primary device depends on the system state—(a) open-loop mode and (b) closed-loop mode.

### Open-Loop

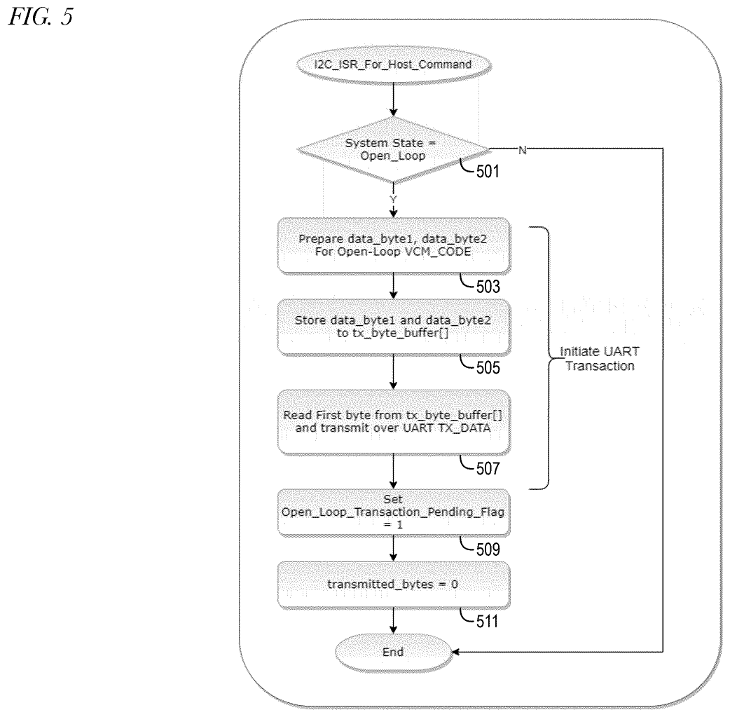

In the open-loop mode, the primary device receives the open-loop DAC code from the host processor over an I2C interface. In the absence of full-duplex UART communication, the primary/secondary synchronization is achieved by the primary device deferring and precisely delaying the application of received open-loop code until after initiating the transmission of open-loop code to the secondary device over UART. On the primary device, indication of the secondary device receiving the VCM Code packet is acknowledged via UART_TX_ISR which triggers upon completion of the UART transmission. The flow-chart shown in FIG. 5 outlines the handling of open-loop code on the primary device in an I2C ISR that services host processor command for open-loop DAC codes.

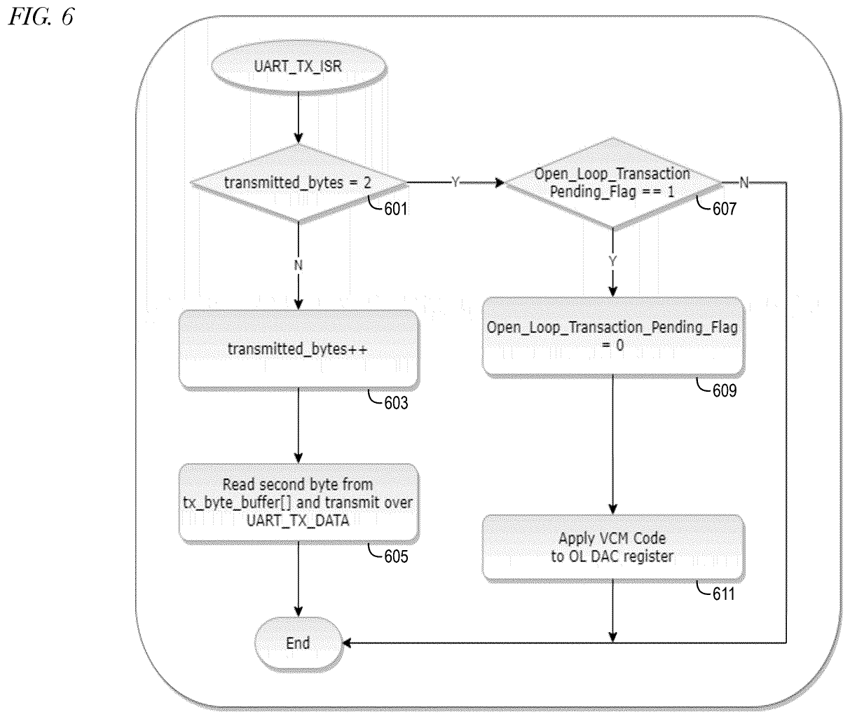

As shown in the above flow-chart of FIG. 5, in the open-loop mode (block 501), the primary device forms VCM packet and initiates transfer over UART (blocks 503 through 507). The primary device also sets the Open_Loop_Transaction pending flag (blocks 509 and 511) indicating that upon completion of transmission of the UART packet (blocks 601 through 609), open-loop VCM code needs to be applied to the output driver (block 611) on the primary device in the UART Transmit ISR—UART_TX_ISR. The flow-chart of FIG. 6 outlines UART_TX_ISR.

### Closed-Loop

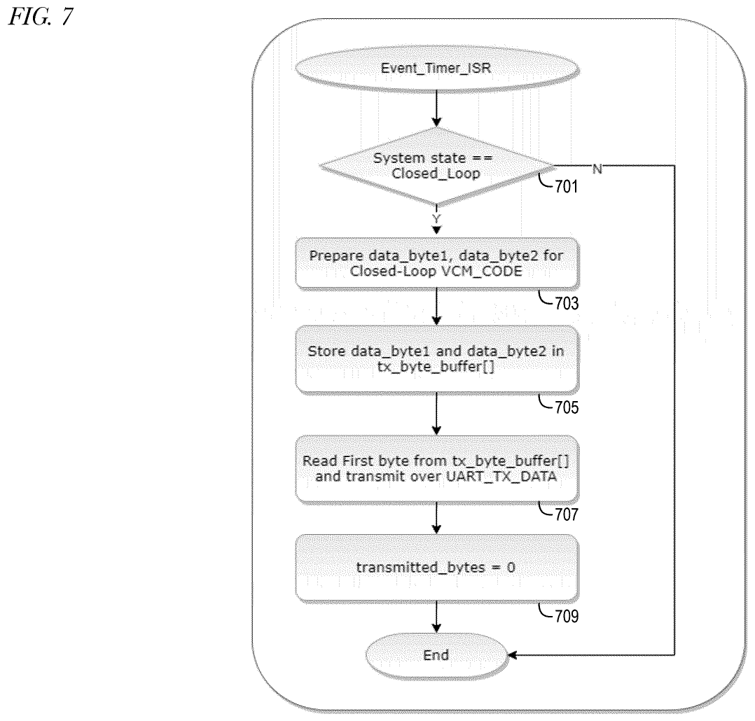

In the closed-loop mode of operation (block 701), there is a fixed but programmable cadence of application of closed-loop DAC codes to the output driver with respect to each instance of the control-loop. Each instance of the control loop computes the closed-loop VCM codes (blocks 703 and 705) based on the sensor inputs and host position command. However, the application of the closed-loop VCM codes to the output driver is hardware assisted and takes place after a programmable delay from the start of each control loop instance. In order to synchronize the application of VCM codes between the primary device and the secondary device, the primary device uses the Event Timer capability of the hardware. Event Timer produces an event/interrupt at a programmable delay with respect to an external trigger. In this case, the commencement of each instance of the control loop starts the count-down of the Event Timer. The programmable delay between the commencement of each instance of control-loop and the event on the primary device is programmed such that the event is triggered just enough before the hardware pick-up of closed-loop DAC code to both facilitate the transmission (blocks 707 and 709) and to account for the time to transmit the VCM code packet and its application on the secondary device to approximately coincide with the hardware pickup on the primary device. Handling of transmission of VCM code in Event_Timer_ISR is depicted in the flow-chart of FIG. 7.

### Run-Time Execution Context

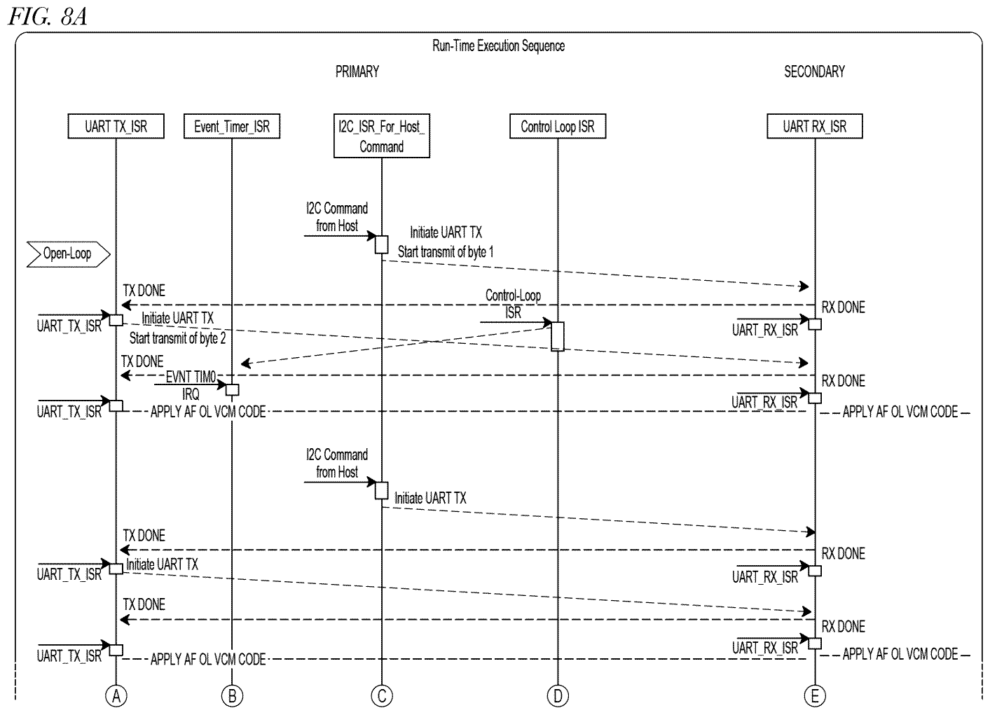

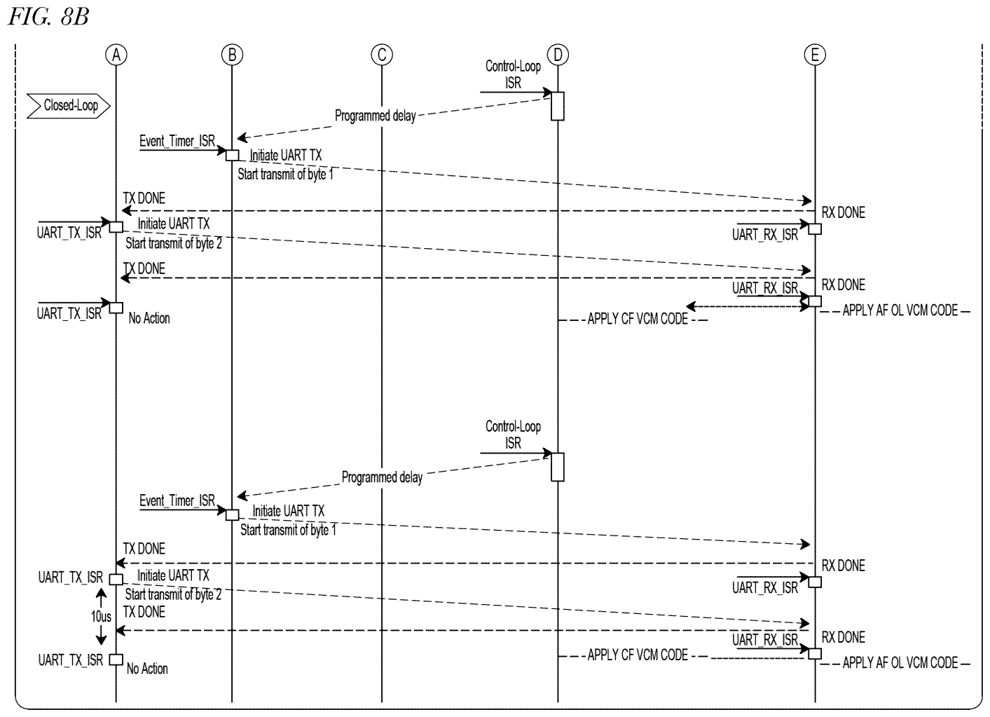

The run-time execution flow for the open-loop and closed-loop system states is depicted in FIGS. 8A and 8B, referred to collectively as FIG. 8. As shown in FIG. 8, the primary/secondary synchronization is achieved in both the system states. The use of Event Timer has been demonstrated to precisely control the timing of transmission of closed-loop codes so that hardware DAC pick-up on the primary device happens at the same time when these codes are received and applied on the secondary device.

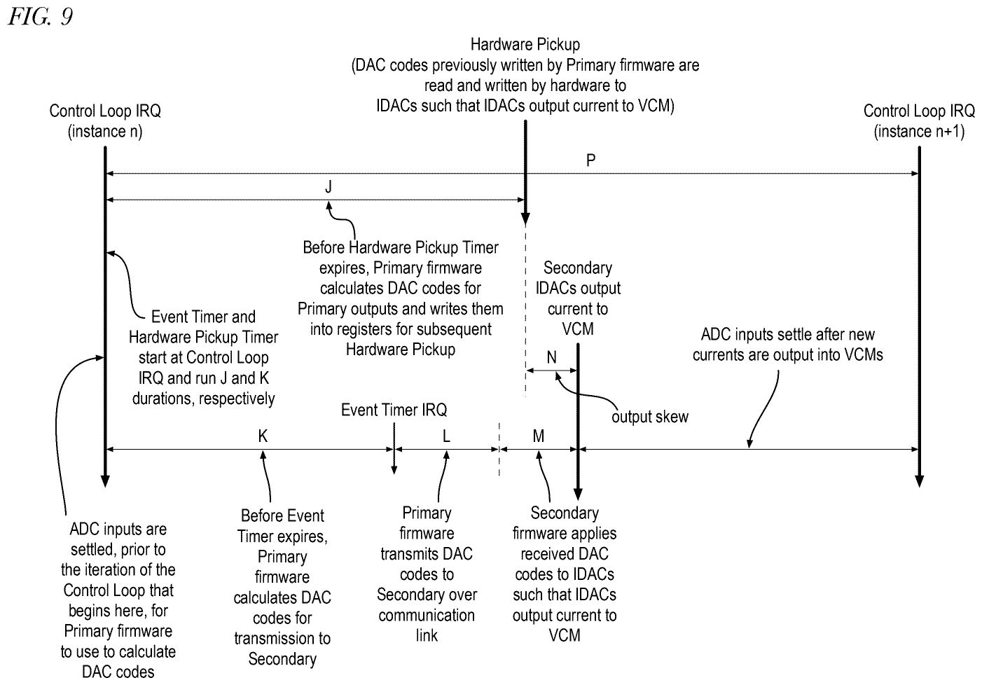

FIG. 9 is an example timing diagram illustrating operation of the system 100 of FIG. 1 according to embodiments of the present disclosure. FIG. 9 depicts in horizontally increasing time operation of the system 100 in closed-loop mode similarly depicted in vertically increasing time in FIG. 8. It is noted that although the system 100 is operating as a whole in closed-loop mode, the secondary device continues to operate in open-loop mode. That is, although the primary device periodically updates its outputs and transmits DAC codes to the secondary device in a closed-loop fashion to accomplish a command (e.g., camera position) previously received from the host processor (potentially many closed loop intervals ago), the secondary device always operates in open-loop mode, i.e., it always applies the DAC codes received from the primary device as soon as possible after being received.

At initialization of the primary device, the primary device is programmed with three timer values. First, a control loop timer is programmed with a delay shown in FIG. 9 as P (e.g., 200 microseconds). The control loop timer periodically triggers to generate a control loop IRQ. Two instances of the control loop IRQ are shown. Second, an event timer is programmed with a delay shown in FIG. 9 as K (e.g., 80 microseconds). The control loop timer begins to run when the control loop IRQ triggers and runs for K time at the end of which a control loop IRQ triggers. Third, a hardware pickup timer is programmed with a delay shown in FIG. 9 as J (e.g., 120 microseconds). The hardware pickup timer begins to run when the control loop IRQ triggers and runs for J time at the end of which the pickup hardware of the primary device picks up DAC codes previously written into registers of the primary device and applies the DAC codes to the current DACs of the primary device so that the current DACs output current to the camera VCMs (or other controlled elements of other devices in alternate embodiments).

Prior to the control loop IRQ, ADC inputs received from the camera VCMs (or other inputs from other devices in alternate embodiments) have settled and are available for use by the primary device firmware to calculate DAC codes for the control loop iteration that is about to start. Before the event timer expires, i.e., before the event timer IRQ triggers, the firmware of the primary device calculates DAC codes based on the settled ADC inputs for transmission to the secondary device. Additionally, before the hardware pickup timer expires, the firmware of the primary device calculates DAC codes based on the settled ADC inputs for application by the pickup hardware to the outputs of the primary device.

In response to the event timer IRQ, the primary device transmits the DAC codes to the secondary device over the communication link according to the operation shown in FIG. 7, for example. The primary device firmware execution and DAC code transmission time is shown in FIG. 9 as a time L from the event timer IRQ. In response to receiving the DAC codes, the secondary device applies in an open loop fashion (i.e., as soon as possible and without delay) the received DAC codes to its current DACs so that the current DACs output current to the camera VCMs according to the operation shown in FIG. 4, for example. The secondary device firmware execution time is shown in FIG. 9 as a time M from reception of the DAC codes. Thus, the outputs of the secondary device generate the new current values to the camera VCMs at a point in time that is effectively K plus L plus M after the control loop IRQ, as shown. As described above, the outputs of the primary device generate the new current values to the camera VCMs in response to the hardware pickup that occurs a programmable time J after the current loop IRQ, as shown. The time between the output by the primary device and the secondary device is the primary/secondary output skew described above, which is shown as time N in FIG. 9. After the outputs generate the new current values to the VCMs, the ADC inputs from the sensors at the VCMs begin to settle and are settled prior to the next instance of the control loop IRQ.

As described above, the difference between the hardware pickup timer delay (J) and the event timer delay (K) is chosen to accomplish a couple of competing goals. One goal is to reduce the output skew (N), based on the primary device firmware delay plus transmission time (L) and the secondary device firmware delay (M). Another goal is to provide the firmware of the primary device sufficient time to calculate the secondary and primary DAC codes before the event timer triggers and the hardware pickup timer triggers, respectively. Advantageously, the values of J and K are programmable and therefore are effectively “knobs” that may be adjusted to tune the system 100 to meet the need of the application, e.g., camera control.

As described above, each of the primary and secondary devices may be separately configured to operate in either open loop mode or in closed loop mode. However, in the embodiments described, the secondary device is always configured to operate in the open loop mode. When the primary device is configured in the closed loop mode, the host processor sends information to the primary device (e.g., via the I2C interface), e.g., camera position information. The primary device then determines the current values that need to be output to the VCM's (via DAC codes) to cause the camera to reach and stay at the position specified by the host processor. Whereas, when the primary device is configured in open loop mode, the host processor directly specifies the current values (or the DAC codes that determine the current values), and the primary device simply applies its portion of the DAC codes and transmits the other portion to the secondary device. In other words, in open loop mode, it is the responsibility of the host processor to get the camera to the desired position without the primary device knowing the position, whereas in closed loop mode it is the responsibility of the primary device to get and keep the camera at the position commanded by the host processor. Furthermore, in open loop mode, the primary device immediately applies the DAC codes received from the host processor to generate the output current; whereas, in closed loop mode, the primary device waits to apply the DAC codes that it calculates to generate the output current until the hardware pickup timer triggers, which is periodic and programmable. For example, when the device in which the system 100 is included (e.g., phone with a camera) is started up (e.g., powered on or reset), the host processor of the phone may configure the primary device in open-loop mode to send DAC codes that coarsely position the lens of the camera, e.g., to a default position. Later, the host processor may receive more information (e.g., based on user input) about where the lens needs to be positioned and configures the primary device in closed-loop mode and sends the position to the primary device, in response to which the primary device positions the camera lens more finely and maintains the quality of the position of the camera lens.

Advantageously, the primary and secondary devices work together to appear to the host processor as a single operating entity whose outputs are synchronized. In one embodiment, the secondary device may inform the primary device in the event of a packet integrity failure so that the primary device may retransmit the packet. Additionally, the primary device may notify the host processor of such a failure and retransmission. Further advantageously, the system may be configured in multiple configurations with respect to the multiple outputs provided by the primary/secondary device combination. For example, embodiments are described above in which each of the primary and secondary devices has three outputs. One embodiment is described above in which VCM that controls an Optical Image Stabilization (OIS) subsystem of the camera are driven by two outputs of the primary device, and VCM that control an Auto-Focus (AF) subsystem of the camera are driven by one output of the primary device and by one output of the secondary device. Another embodiment is described above in which the OIS subsystem is driven by two outputs of the primary device and the AF subsystem is driven by two outputs of the secondary device. However, the system may be configured in other combinations according to other embodiments to meet the needs of the application. For example, in one embodiment, there may be separate OIS-X and OIS-Y subsystems, in addition to an AF subsystem. Additionally, the system may be configured in different dimensions to accommodate operation of different subsystems in different modes. For example, the primary device may be configured in closed loop mode for one or more of the subsystems and configured in open loop mode for one or more of the remaining subsystems. Advantageously, the embodiments described herein provide a system in which the primary/secondary device combination appears to the host processor as a single device having N total available outputs when in fact each of the primary and secondary devices individually includes less outputs than the N total outputs. This configuration is advantageous because it alleviates the need for a re-design of the device to provide the needed N total outputs within a single device, which could involve significant investment both in terms of time and cost. Furthermore, in the case that the device is already pin-limited, a re-design may not be possible or may be possible only at the cost of a sacrifice in other features of the device.

As described above, in one embodiment, the Event Timer duration is programmed as an amount of time that begins to run after the Control Loop IRQ event occurs. In an alternate embodiment, the Event Timer duration may be programmed as an amount of time leading up to the hardware pickup, i.e., relative to the hardware pickup rather than relative to the Control Loop IRQ. That is, the Event Timer IRQ occurs the programmed amount of time before the hardware pickup occurs. However, because of the transitive property and the fact that the hardware pickup timer is relative to the Control Loop IRQ, according to the alternate embodiment, the Event Timer IRQ is still effectively specified relative to the Control Loop IRQ event.

Although embodiments have been described for use in controlling a camera, more particularly voice coil motors of a camera, other embodiments are contemplated in which the primary/secondary device combination is used to control other types of devices. Finally, although embodiments are described in which a single secondary device is employed to expand the output capability of the system, other embodiments are contemplated in which an additional secondary device (or multiple additional secondary devices) may be in communication with the primary device—via another communication link between the primary device and the additional secondary device or via a communication link shared by the primary device and the multiple secondary devices—such that the primary device transmits updated values to the additional secondary device and the additional secondary device responsively applies the received updated values on its outputs.

As described above, modern camera controllers may require multiple sensors and voice coil motors (VCM), or other types of actuators, for optical image stabilization (OIS) and auto focus (AF). For a complex system, it may be advantageous to use multiple camera controller devices instead of a single device. Using multiple devices may offer the following advantages. First, multiple devices may increase power drive, since a single device may not have enough output drivers to drive the required power into the voice coil motors. Second, multiple devices enable a modular design since more devices can be added as needed to increase the number of output driver channels, increase the number of sensor channels, and increase the overall signal processing. Third, multiple devices may simplify the programming model by having the host communicate only with the primary device, in mission mode, which in turn communicates with the secondary devices.

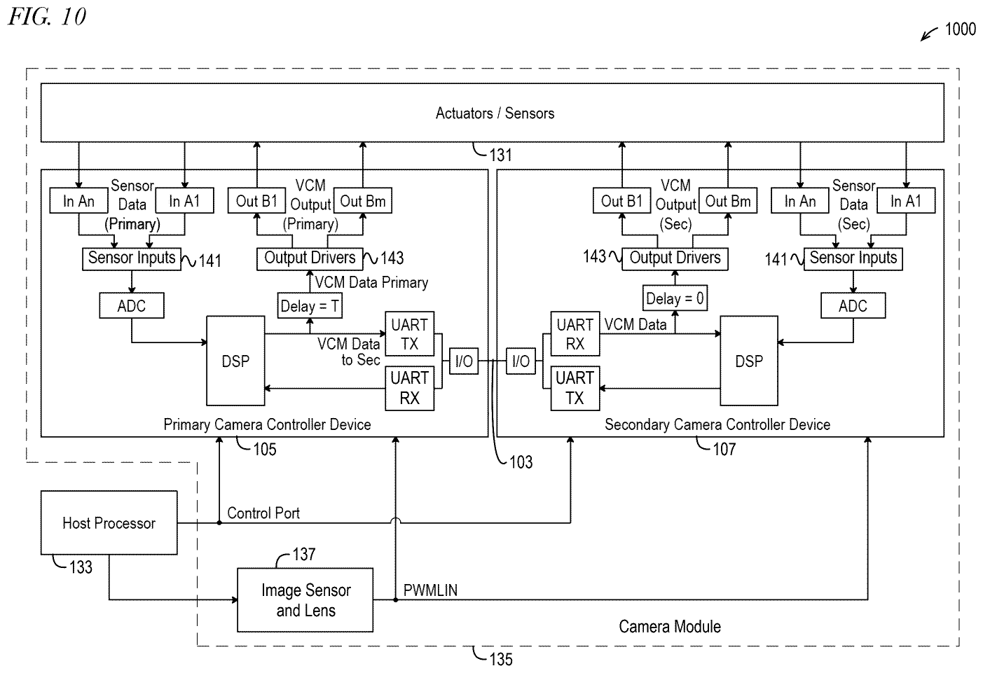

FIG. 10 is an example block diagram illustrating a system 1000 in accordance with embodiments of the present disclosure. The system 1000 includes a host processor 133, an image sensor and lens 137, a primary camera controller device 105 (also referred to herein as the primary device or the primary), a secondary camera controller device 107 (also referred to herein as the secondary device or the secondary), a communication link 103 connecting the primary camera controller device 105 and the secondary camera controller device 107, and actuators/sensors 131. In one embodiment, the image sensor and lens 137, actuator and sensors 131, primary camera controller device 105 and secondary camera controller device 107 are incorporated within a physical entity referred to as a camera module 135.

Each of the primary camera controller device 105 and the secondary camera controller device 107 includes a digital signal processor (DSP), a communication link transmit pad (shown in FIG. 10 as “UART TX”) used to transmit data provided by the DSP over the communication link 103, a communication link receive pad (shown in FIG. 10 as “UART RX”) used to receive data from the communication link 103 for provision to the DSP, and an I/O pin connected to the communication link transmit and receive pads and connected to the communication link 103. Each of the primary camera controller device 105 and the secondary camera controller device 107 also receive from the sensors 131 sensor data (shown in FIG. 10 as “In A1” through “In An”) that are provided to sensor inputs 141, and the sensor inputs 141 are provided to an analog-to-digital converter (ADC) whose digital outputs are provided to the DSP. Each of the primary camera controller device 105 and the secondary camera controller device 107 also include output drivers 143 that receive VCM data, also referred to as control data, from the DSP and drive VCM outputs (shown in FIG. 10 as “Out B1” through “Out Bn”) to control the actuators 131. The output drivers 143 may include a digital-to-analog converter (DAC) to convert digital VCM data to analog VCM outputs. In the embodiment shown in FIG. 10, the primary camera controller device 105 DSP drives the VCM data to the output drivers 143 with a delay (shown in FIG. 10 as “T”) relative to a DSP frame of the primary camera controller device 105, as described in more detail below. The PWMLIN may be used by the image sensor to indicate to the primary and secondary camera controller devices that a picture is being taken by the image sensor so that the primary and secondary camera controller devices may switch to a linear mode in order to reduce interference.

The primary camera controller device 105 is a first package (e.g., integrated circuit, or chip), and the secondary camera controller device 107 is a second package (e.g., integrated circuit, or chip), and the two devices are coupled together by the communication link 103 by which they communicate with one another in the various ways described herein. Advantageously, the communication link 103 enables the tasks of sensing and controlling the image sensor and/or lens 137 to be distributed between the primary camera controller device 105 and the secondary camera controller devices 107. Although embodiments are described with respect to FIG. 10 and other Figures in which there is a single secondary camera controller device 107 in communication with the primary camera controller device 104 via a single communication link 103, other embodiments are contemplated in which the system 1000 includes multiple secondary camera controller devices each in communication with the primary camera controller device via a respective communication link in order to appreciate benefits described herein, e.g., increased power drive, increased number of output driver channels, increased number of sensor channels, increased overall signal processing, and simplified programming model.

The primary and secondary device processing may be configured by the host processor to do one of the following. In a first configuration, sensors are enabled on the primary device only, and the sensor/loop processing is performed only on the primary device. In a second configuration, the sensors are enabled on both the primary and secondary devices, and the sensor/loop processing is performed only on the primary device. In a third configuration, the sensors are enabled on both the primary and secondary devices, and the sensor/loop processing is performed on both the primary and secondary devices.

In the first configuration, motion sensors are enabled on the primary device only. Primary sensor processing is done on the primary device. Control loop processing is done on the primary device. Primary and secondary VCM codes are generated on the primary device. In one embodiment, secondary health sensing (e.g., temperature and voltage) is done on the secondary device.

In each of the three configurations, there are two communication modes: initialization mode and mission mode. In initialization communication mode, at startup, the host processor initializes and configures the primary and secondary devices through the control port of FIG. 1 as follows. The host processor configures the primary and secondary devices, enables the communication link on the primary device, and enables the communication link on the secondary device. The communication link may be a UART. In one embodiment, the UART may be similar to the UART 109 of FIG. 1. Once initialized, the devices transition to mission communication mode where the host communicates mainly with the primary device. The host may need to communicate with the secondary device in case of an error or to restart the system.

There are two modes of operation: open loop mode and closed loop mode. In the open loop mode, the primary and secondary VCM code values are directly controlled by the host. The host enables open loop mode on the primary device. The host periodically writes the primary and secondary DAC codes to the primary device. The primary device sends the secondary VCM data packet to the secondary device, which may contain the following information: a digital-to-analog converter (DAC) code, a status request byte, and a frame termination byte, or flush byte (e.g., with a value of 0xFF). After a fixed delay to match the communication link latency, the primary device applies the primary DAC codes to the primary device. When the 0xFF frame termination byte is received by the secondary device, the secondary device checks for errors and, if no errors are detected, the secondary device applies the DAC code data to its output drivers. When requested by the host, the primary device sends a status request as part of the DAC code packet to the secondary device. When requested by the primary device, the secondary device responds back with device and link status information, which may include device status (device warnings, errors), device temperature and voltage measurements, and communication link status. A timeout error may be generated if the primary device does not receive the secondary response within the timeout period.

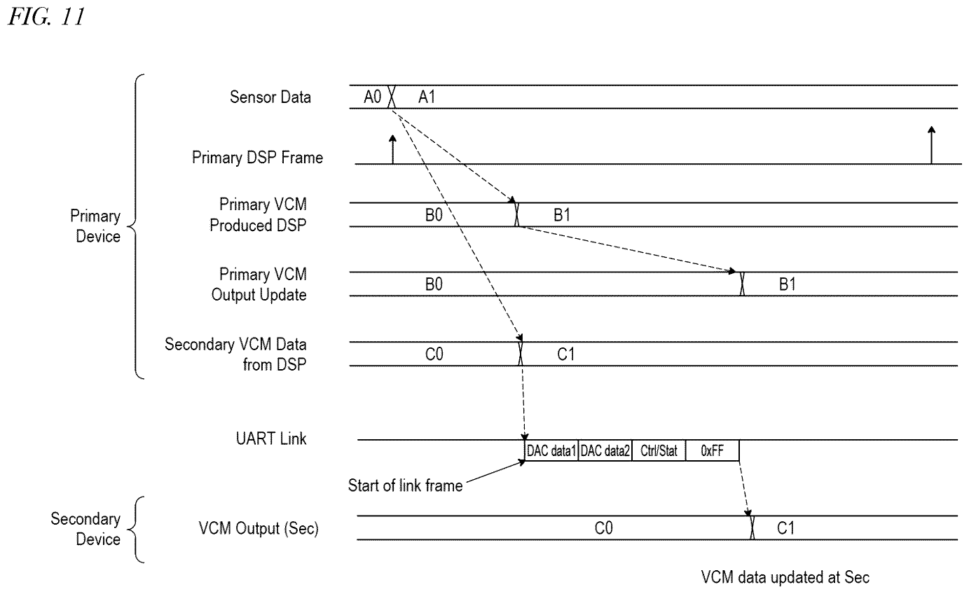

FIG. 11 is an example timing diagram illustrating operation in the first configuration in the closed loop mode in accordance with embodiments of the present disclosure. In the closed loop mode of operation, the host enables closed loop mode on the primary device. The primary device processes sensor information and position codes from the host at a fixed frame rate. In each frame, the primary device DSP produces the DAC codes for the primary and secondary output drivers and sends the secondary device its DAC codes. When the 0xFF frame termination byte is received by the secondary device, the secondary device checks for errors and, if no errors are detected, the secondary device applies the DAC code data to its output drivers. For every N number of frames, where N is programmable integer, the primary device requests secondary status information. When requested by the primary device, the secondary device responds back with device and link status information, which may include device status (device warnings, errors), device temperature and voltage measurements, and communication link status. A timeout error may be generated if the primary device does not receive the secondary response within the timeout period.

As stated above, there are two configurations (second and third configurations) in which the camera sensors are enabled on the primary and secondary devices. In the second configuration, all loop processing is done on the primary device. In the third configuration, primary loop processing is done on the primary device, and secondary loop processing is done on the secondary device. When the camera sensors are enabled on the secondary device (and the primary device), the secondary DSP frame is synchronized to the primary DSP frame to minimize the latency between the VCM data updates on the two devices.

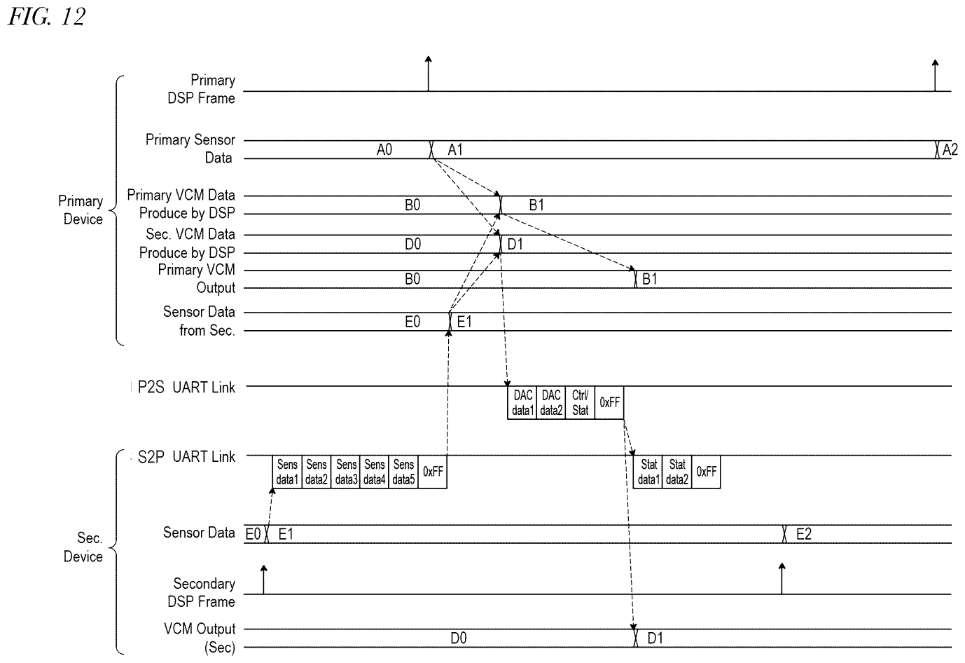

FIG. 12 is an example timing diagram illustrating operation in the second configuration (camera sensors enabled on primary and secondary, and all loop processing is done on the primary device) in the closed loop mode in accordance with embodiments of the present disclosure. In the second configuration, secondary sensor data (E1) is captured at the start of the secondary DSP frame. The secondary DSP frame is timed to start before the start of the primary DSP frame to allow enough time for the secondary sensor data to be transferred to the primary device. Primary sensor data (A1) is captured at the start of the primary DSP frame. The primary DSP processes the control loop data. The primary DSP takes primary sensor data (A1), secondary sensor data (E1), VCM position data from the host and produces the VCM DAC data for the primary device (B1) and for the secondary device (D1). The secondary VCM data D1 is transferred through the communication link to the secondary device. After a latency equal to the secondary VCM data transfer through the communication link, the primary device applies its VCM Data. At about the same time, the secondary device also applies its VCM data.

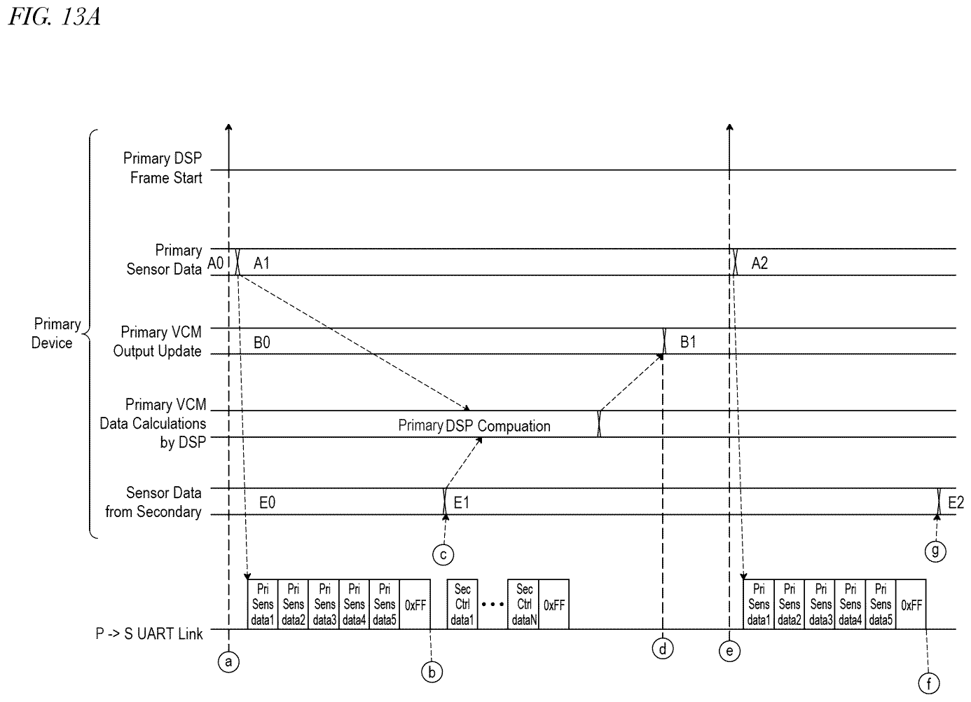

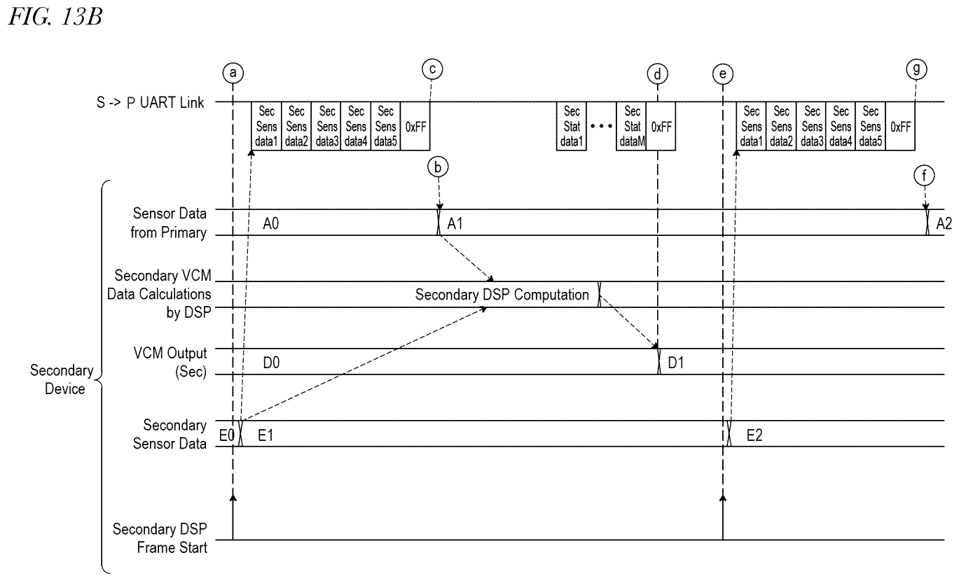

FIG. 13 (FIGS. 13A and 13B are referred to collectively as FIG. 13) is an example timing diagram illustrating operation in the third configuration (camera sensors enabled on primary and secondary, and primary loop processing is done on the primary device, and secondary loop processing is done on the secondary device) in the closed loop mode in accordance with embodiments of the present disclosure. Operation in the third configuration is similar to operation in the second configuration, however in the third configuration, each device does its own loop processing to produce its VCM outputs. The individual loop processing allows shorter loop latency at the expense of more data transferred from primary to secondary. As shown, primary sensor data and host VCM position data are transferred to the secondary device at the start of each DSP frame. The primary device may send control data (register writes/reads) to the secondary device on each DSP frame. The secondary device periodically sends status data to the primary device and in response to primary register read commands. Secondary data is transferred to the secondary device at the start of each DSP frame. To minimize the latency between the primary and secondary devices, the secondary DSP frame may be synchronized to the primary DSP frame. More specifically, the DSP frame, sensor data sampling, and DAC output updates are synchronized between the primary camera controller device and the secondary camera controller device, as shown. To accommodate the higher transfer rate, the link can be operated in full duplex mode or half duplex at a higher data rate. FIG. 13 illustrates the primary to secondary and secondary to primary transfers using the link in full duplex mode.

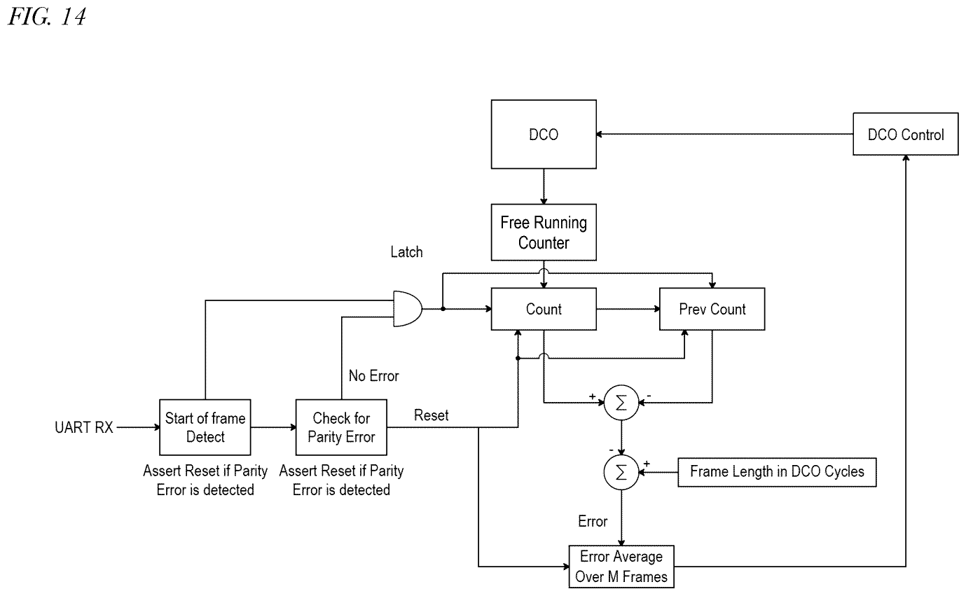

FIG. 14 is an example block diagram illustrating use of a free running counter on the secondary device to accomplish secondary to primary DSP frame synchronization in accordance with embodiments of the present disclosure. When the camera sensors are enabled on the secondary device, the secondary DSP frame is synchronized to the primary DSP frame to minimize the loop latency. To accomplish the secondary to primary DSP frame synchronization, the free running counter is used on the secondary device to measure the incoming communication link frame period. In a first step, the primary device sends data (VCM or sensor) packets at a fixed delay relative to its DSP frame. In a second step, on the secondary device, the VCM UART header frame is detected. If no errors are detected on the received UART frame, the counter output is latched, and M is set equal to 1. In a third step, on the subsequent error free UART header frame detection, the free running counter output is latched and subtracted from the value latched in the second step. If an error is detected, the process goes back to the second step. In a fourth step, the frequency error is calculated by subtracting the delta value in the third step from the expected frame period. In a fifth step, the third and fourth steps are repeated for M frames. In a sixth step, the average is calculated over M frames. In a seventh step, the digitally controlled oscillator (DCO) frequency is adjusted by a code corresponding to the calculated frequency error. In an eighth step, the second through seventh steps are repeated.

Embodiments of communication link configurations will now be described. There are two communication link configurations. The communication link between the primary and secondary devices may be configurated in a half-duplex configuration or in a full-duplex configuration.

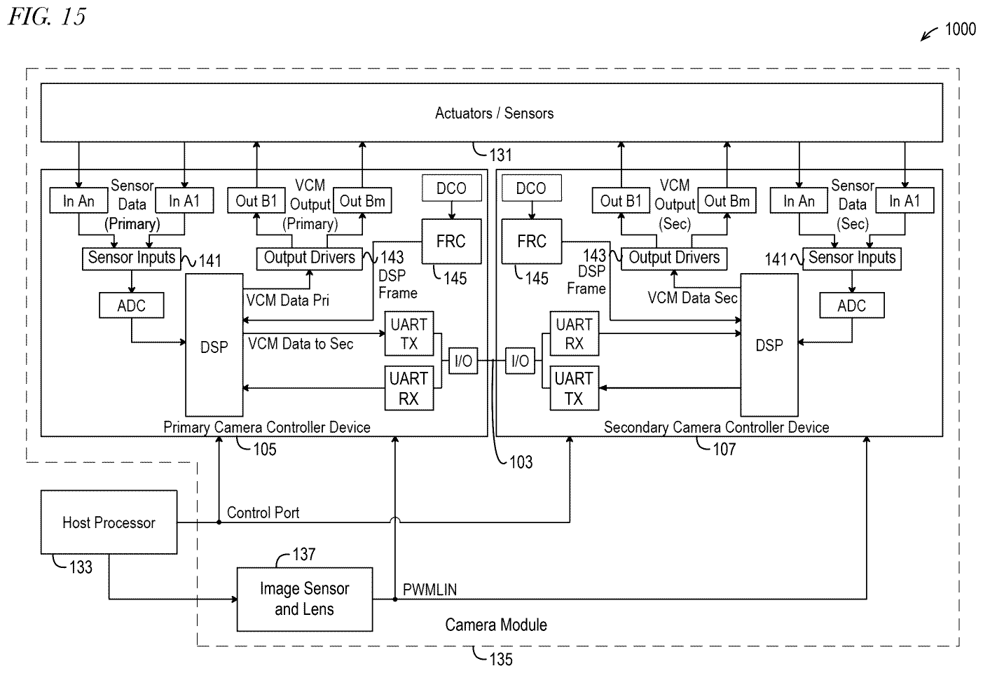

FIG. 15 is an example block diagram illustrating a system 1000 in a half-duplex configuration in accordance with embodiments of the present disclosure. The system 1000 of FIG. 15 is similar in many respects to the system 1000 of FIG. 10. In the system 1000 of FIG. 15, each of the primary camera controller device 105 and the secondary camera controller device 107 also is shown to include the DCO and the free running counter (FRC) of FIG. 14 that provides its output to the DSP.

In a half-duplex configuration, a single wire is used as the communication link for data transmission between the primary and secondary devices, as shown in FIG. 15. The UART transmit (TX) pad may be push pull or open drain. A pull-up resistor (internal or external) or a bus keeper may be used to keep the link in a high state when the primary and secondary devices are not driving. In half-duplex mode, the following protocol is followed. The primary device defaults to transmit mode. The secondary device defaults to receive mode. When the secondary status is requested, the primary device disables its output and enables its input for reception, and the secondary device enables its output for transmission and disables its input. When the secondary device completes its transmission, the secondary device switches to receive mode. After a timeout period, the primary device switches to transmit mode. The primary device sets a timeout error if it does not receive a response from the secondary device when requested. The primary and secondary devices continuously monitor UART TX. When contention is detected on the UART TX pad, an error bit will be set, and the TX drivers are disabled, e.g., by tri-stating the UART TX pad. Furthermore, the primary and secondary devices automatically tri-state if a major chip error is detected, such as an over temperature condition or expiration of a watch dog timer.

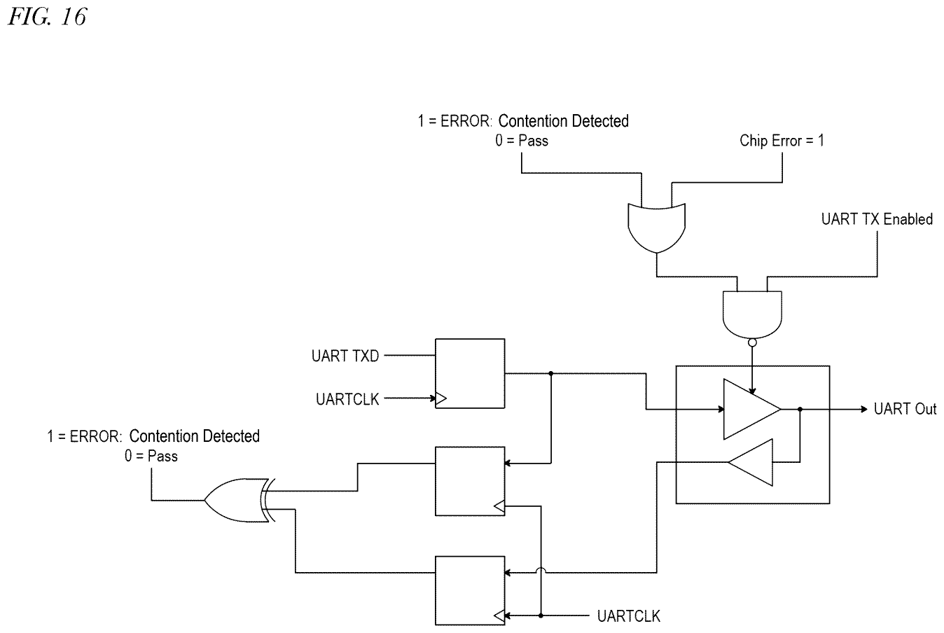

FIG. 16 is an example block diagram illustrating circuitry that performs UART TX pad disabling when bus contention or a chip error is detected in accordance with embodiments of the present disclosure. The primary and secondary devices continuously monitor the TX output pad to check for UART TX pad contention, which happens if the primary and the secondary devices simultaneously drive the UART communication link in half-duplex mode. The contention detection is done by comparing the TX pad input signal against a looped back version of the TX pad output signal. If the two signals are different, an error bit is set, and the TX pad is disabled.

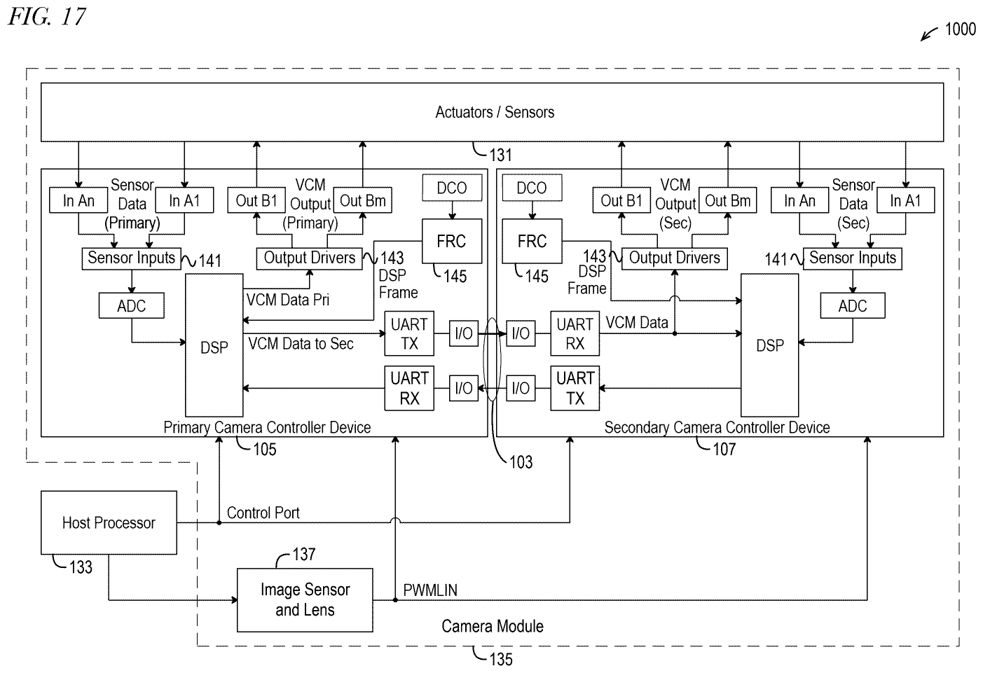

FIG. 17 is an example block diagram illustrating a system 1000 in a full-duplex configuration in accordance with embodiments of the present disclosure. The system 1000 of FIG. 17 is similar in many respects to the system 1000 of FIG. 15. In the system 1000 of FIG. 17, each of the primary camera controller device 105 and the secondary camera controller device 107 includes two I/O pins—one connected to the UART TX pad and the other connected to the UART RX pad, and the communication link 103 includes a pair of wires connecting the respective pairs of I/O pins between the primary camera controller device 105 and the secondary camera controller device 107.

In a full-duplex configuration, two UART links are used, which enables higher transmission bandwidth at the expense of an additional physical connection between the primary and secondary devices. The primary transmit (TX) is connected to the secondary receive (RX). The primary RX is connected to the secondary TX. Since the primary and secondary devices drive separate wires, there is no need to switch between transmit and receive modes, and there is no possibility for bus contention. The primary and secondary UART TX are always enabled. The primary device sets a timeout error flag if the primary device does not receive a response from the secondary device.

To accomplish link health monitoring, the primary device periodically requests status information from the secondary device, which may include device status (device warnings, errors), communication link status (e.g., parity errors or packet sequence errors), and device temperature and voltage measurements. The secondary device checks for parity errors on received data, checks for packet sequence errors, and checks for an 0xFF byte at the end of a packet.

The primary device may make the following status information available to the host: secondary-to-primary timeout error indicator, a secondary-to-primary parity error indicator, a packet sequence error indicator, a status sequence counter, and a packet error counter. The primary device sets the secondary-to-primary timeout error indicator to a true value if a timeout has occurred waiting for a packet from the secondary device. The primary device sets the secondary-to-primary parity error indicator to a true value when the primary device detects a parity error in a received packet from the secondary device. The primary device sets the packet sequence error indicator to a true value if the secondary device sets the Packet Sequence Error bit in the Secondary Status and ACK packet. The status sequence counter is a count of valid status packets received by the primary device from the secondary device. The packet error counter is a count of missed secondary-to-primary packets (e.g., packets for which a timeout occurred), dropped secondary-to-primary packets (e.g., packets for which a parity error was detected), and NACK status packets.

In one embodiment, the inter-chip communication protocol used by the communication link for data transmission is a UART protocol. Information is sent using UART data bytes framed to comprise: a start bit, 7 data bits transmitted least significant bit (LSB) first, an odd parity bit, and a stop bit, as shown in the example embodiment of FIG. 18.

Embodiments of a packet structure used on the communication link will now be described. In the primary device to secondary device packet structure, all packets start with a header byte that specifies the type of packet, as shown in the example embodiment of FIG. 19. There are two types of packets from primary to secondary: VCM DAC data packet and command packet. The packet type is set with a COM bit in the header byte. COM=0 indicates a VCM DAC data packet type, and COM=1 indicates a command packet.

FIG. 20 is an example block diagram of a VCM DAC data packet in accordance with embodiments of the present disclosure. A description of the bit fields in the packet structure is shown

TABLE 1

| | |
|---|---|
| VCM | 12-bit VCM DAC code split into VCM[11:6] and VCM[5:0] and |
| | carried in byte 1 and 2, respectively |
| BSEQ | Byte Sequence |
| | 0 indicates first half (MSB) of VCM DAC code |
| | 1 indicates second half (LSB) of VCM DAC code |
| PAR | Odd Parity Bit |
| Packet Counter[3:0] | Packet Sequence Counter - Counts from 0 to F and repeats. |
| PSYNC | Packet SYNC - Forces Secondary to Synchronize to the value in |
| | Packet Counter[3:0] (typically 0) |
| STAT_REQ[1:0] | Status Request - 2-bit request and Operating Mode |
| | 00 = Open Loop DAC CODE + Secondary Status and ACK |
| | Packet request |
| | 01 = Closed Loop DAC CODE only, no response requested |
| | from Secondary Device |
| | 10 = Closed Loop DAC CODE + Secondary Status and ACK |
| | Packet request |
| | 11 = Open/Closed Loop DAC CODE + Extended Status and |
| | ACK Packet request |
| TX Flush Byte | The TX_FLUSH_BYTE byte is required to indicate that the last |
| | valid data byte has successfully been transmitted |

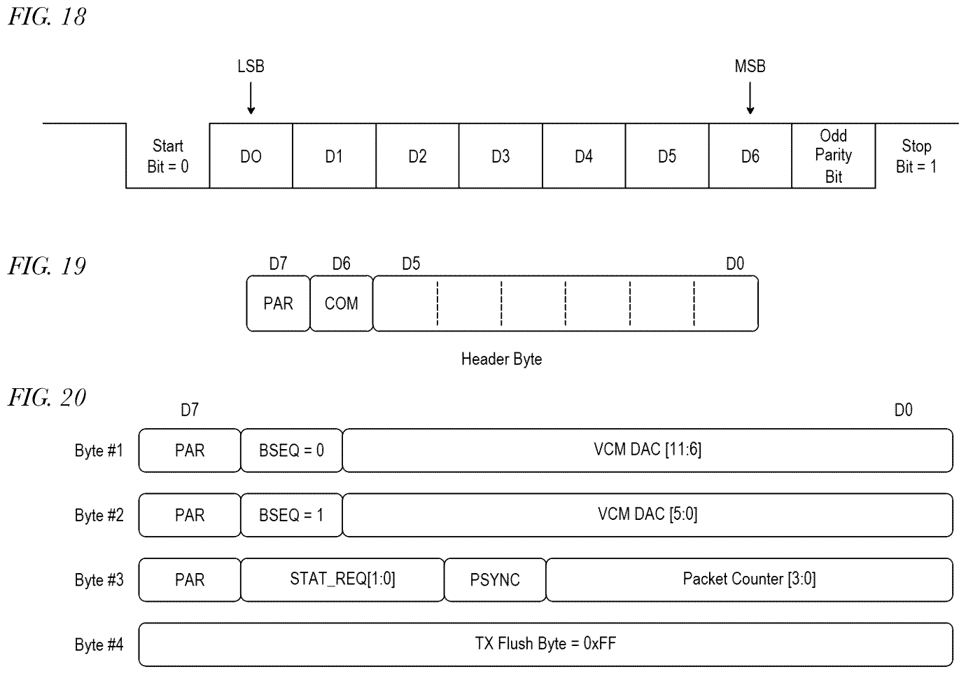

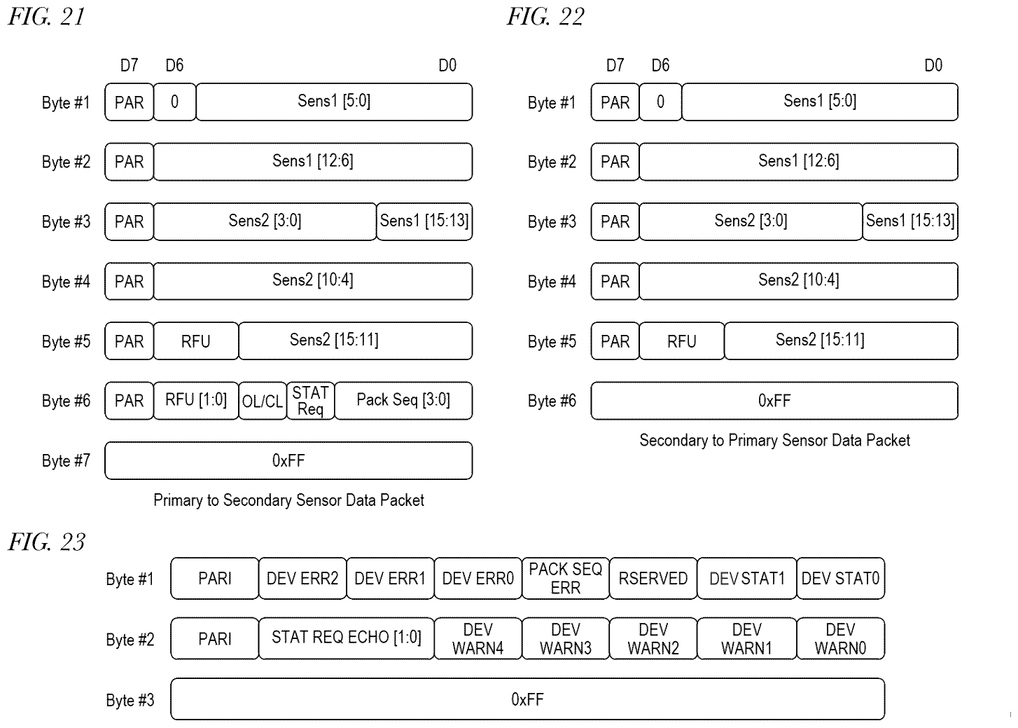

Sensor data packets are normally used when sensors are enabled on the secondary device. Sensor data may be sent from the primary device to the secondary device (e.g., in the third configuration) and from the secondary device to the primary device (e.g., in the second and third configurations). Primary sensor data may be sent from the primary device to the secondary device, e.g., via the primary to secondary (P2S) sensor data packet shown in the example embodiment of FIG. 21, where it is combined with the secondary device sensor data to produce the VCM DAC data. A secondary to primary (S2P) sensor data packet is similar to the P2S sensor packet, but without the status request byte, as shown in the example embodiment of FIG. 22. In the Figures, fields that are reserved for future use are indicated by “RFU”.

A secondary device status packet may be sent by the secondary device to the primary device when STAT_REQ in the P2S sensor data packet is set to a true value by the primary device. In one embodiment, the primary device may request the status packet every Nth frame, where N is configurable by the host. In one embodiment, the secondary status packet (also referred to as an ACK packet) has three bytes, an example of which is shown in FIG. 23, and a description of the bit fields in the packet structure is shown in Table 2 below.

TABLE 2

| Bit Field | Description |
|---|---|
| Status 0 | Secondary device status 0 |
| Status 1 | Secondary device status 1 |
| Packet Sequence Error | Secondary Device Packet Count and Packet Counter value in the last |
| | packet/recent packets received by the Secondary Device did not match |
| | (indicated once per each jump in difference) |
| Warn 0 | Device Warn 0 |
| Warn 1 | Device Warn 1 |
| Warn 2 | Device Warn 2 |
| Warn 3 | Device Warn 3 |
| Warn 4 | Device Warn 4 |
| PAR | Odd Parity |
| STAT_REQ_ECHO[1:0] | Echo of the STAT_REQ[1:0] value received in the preceding VCM |
| | DAC Data Packet |
| Error 0 | Device Error 0 |
| Error 1 | Device Error 1 |
| Error 2 | Device Error 2 |
| TX Flush Byte | The TX_FLUSH_BYTE byte is required to indicate that the last valid |
| | data byte has successfully been transmitted |

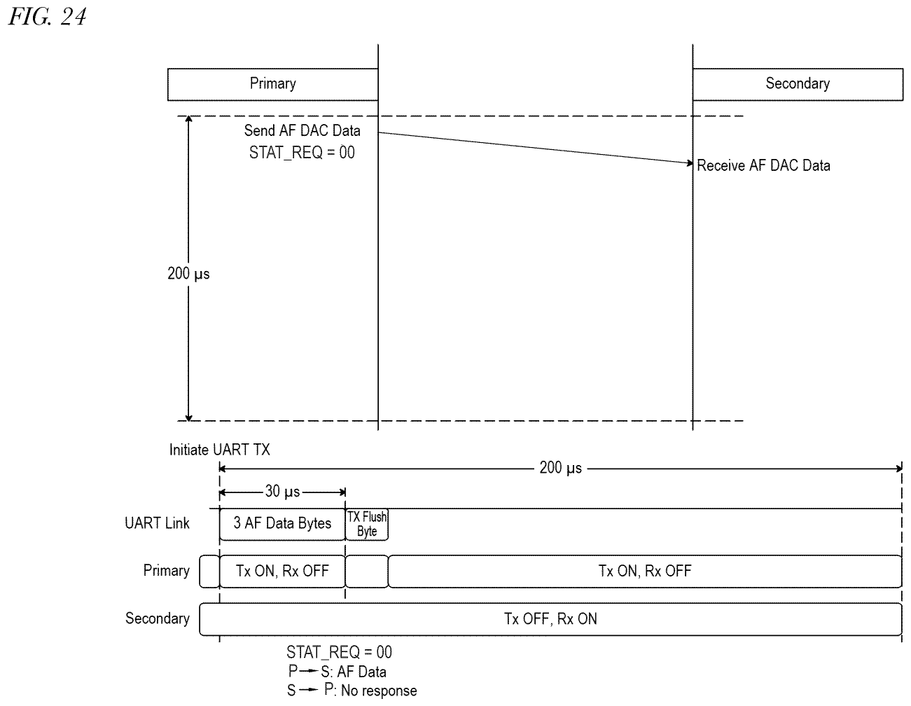

FIG. 24 is an example timing diagram illustrating communication between the primary device and the secondary device when the primary device transmits a VCM DAC data packet with STAT_REQ=0 in accordance with embodiments of the present disclosure. As shown, for a half-duplex configuration, the primary device enables TX and disables RX. The primary device sends VCM DAC bytes with STAT_REQ=0. At the end of TX, the primary device disables TX and enables RX. The secondary device receives the three bytes and does not respond, since STAT_REQ=0. For the half-duplex configuration, the secondary device keeps its TX disabled and RX enabled since STAT_REQ=0.

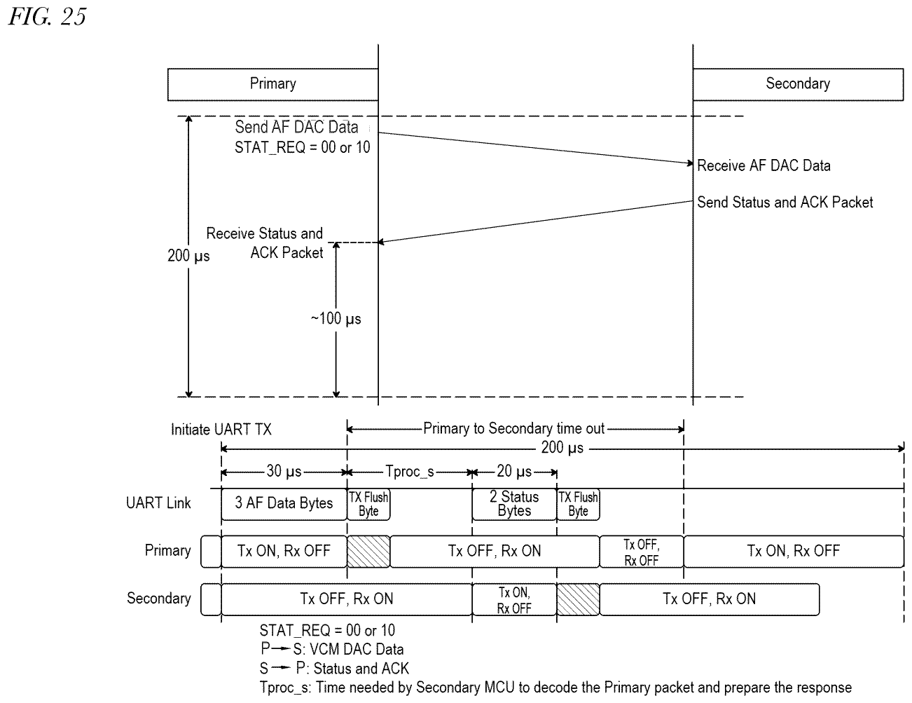

FIG. 25 is an example timing diagram illustrating communication between the primary device and the secondary device when the primary device transmits a VCM DAC data packet with STAT_REQ=1 in accordance with embodiments of the present disclosure. As shown, the primary device sends VCM DAC bytes with STAT_REQ set to 1. For a half-duplex configuration, at the end of TX, the primary device disables TX and enables RX. The secondary device receives the VCM DAC packet and checks if STAT_REQ=1. For a half-duplex configuration, the secondary device enables its TX and disables its RX. The secondary device sends back a secondary status packet, as shown.

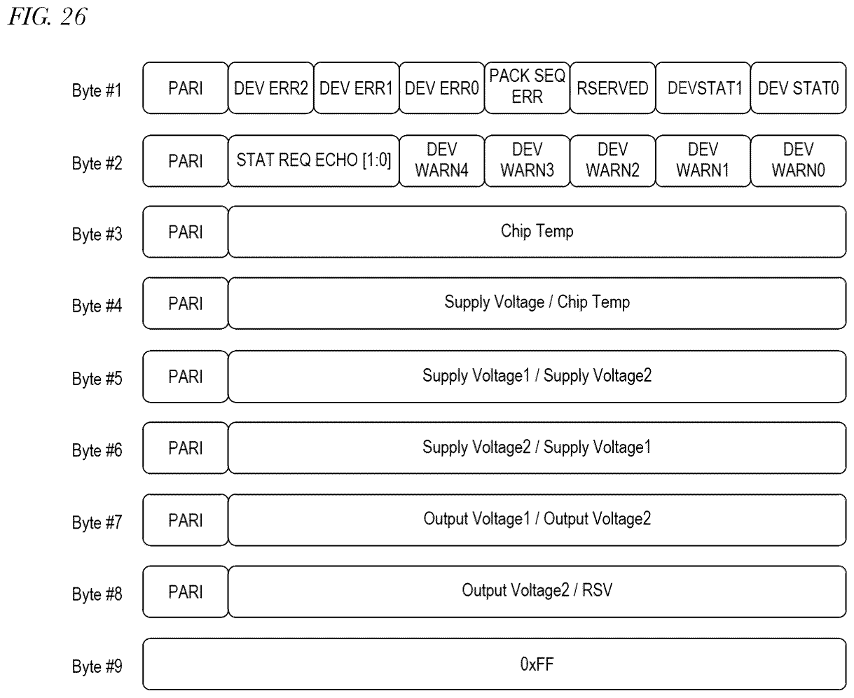

FIG. 26 is an example block diagram illustrating an extended secondary status packet in accordance with embodiments of the present disclosure. Extended secondary status packets, also referred to as extended status and ACK packets, are sent from the secondary device to the primary device when requested by the primary device. The first two bytes of the extended secondary status packet are the same as a secondary status and ACK Packet, and the remaining bytes contain secondary device temperature and voltage data. The extended secondary status packet is nine (9) bytes long for two secondary output drivers and may be extended. A description of the bit fields in the extended secondary status packet is shown in Table 3 below.

TABLE 3

| Bit | Description |
|---|---|
| Packet Sequence Error | Secondary Device Packet Count and Packet Counter value in |
| | the last packet/recent packets received by the Secondary |
| | Device did not match |
| Warn 0 | Device Warn 0 |
| Warn 1 | Device Warn 1 |
| Warn 2 | Device Warn 2 |
| Warn 3 | Device Warn 3 |
| Warn 4 | Device Warn 4 |
| PAR | Odd Parity |
| STAT_REQ_ECHO[1:0] | Echo of the STAT_REQ[1:0] value received in the preceding |
| | VCM DAC Data Packet |
| Error 0 | Device Error 0 |
| Error 1 | Device Error 1 |
| Error 2 | Device Error 2 |
| Chip temp | Secondary Device's Internal Temperature measurement |
| Supply Voltage 1_ | Secondary Device's Field supply1 voltage measurement |
| Supply Voltage 1_ | Secondary Device's supply2 voltage measurement |
| Output Voltage 1 | Secondary Device's B1 driver output voltage measurement |
| Output Voltage 2 | Secondary Device's B2 driver output voltage measurement |
| TX Flush Byte | The TX_FLUSH_BYTE byte is required to indicate that the |
| | last valid data byte has successfully been transmitted |

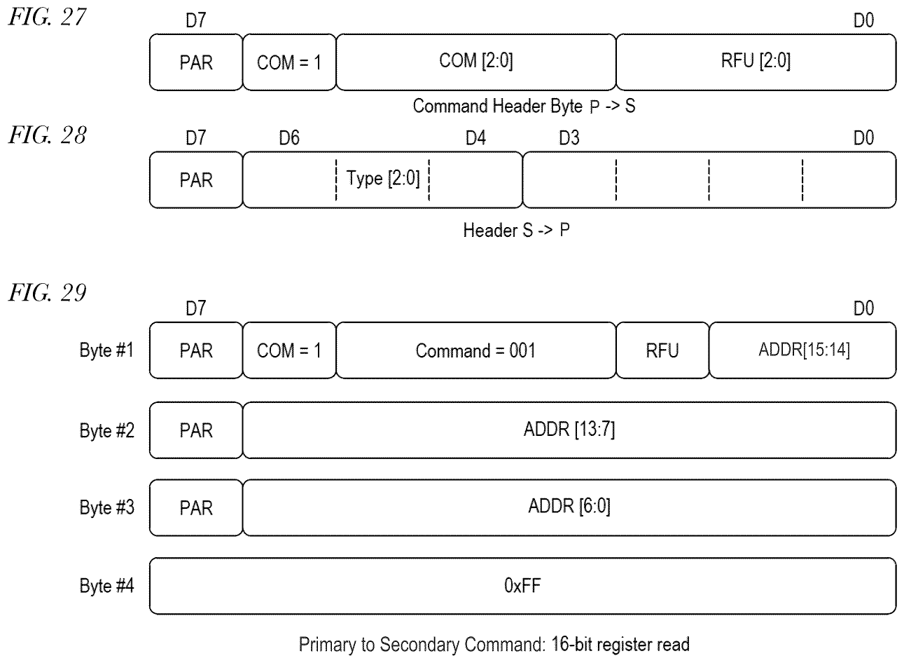

FIG. 27 is an example block diagram illustrating a primary to secondary command packet header in accordance with embodiments of the present disclosure. The primary device sends command packets to the secondary device to request register reads and writes. Command packets start with the header byte in which the COM bit=1, as shown in FIG. 27. A description of the command field (COM[2:0]) values in the primary to secondary command packet header are shown in Table 4 below.

TABLE 4

| Command | Description | Comments |
|---|---|---|
| 0 | Reserved | Reserved |
| 1 | 16-bit Read | 16-bit Secondary Read |
| 2 | 32-bit register Read | 32-bit Secondary Read |
| 3 | 16-bit Write | 16-bit Secondary Write |
| 4 | 32-bit Write | 32-bit Secondary Read |
| 5 . . . 7 | Reserved | Reserved |

FIG. 28 is an example block diagram illustrating a secondary to primary response packet header in accordance with embodiments of the present disclosure. The secondary to primary response packets may be a response to a register read command or a response to a register write command. The secondary to primary response packet starts with a header byte, shown in FIG. 28, that contains a type field that indicates the type of information contained in the secondary to primary response packet. A description of the type field (Type[12:0]) values in the secondary to primary response packet header are shown in Table 5 below.

TABLE 5

| Type | Description |
|---|---|
| 0 | Reserved |
| 1 | 16-bit Read |
| 2 | 32-bit Read |
| 3 | 16-bit Write |
| 4 | 32-bit Write |
| 5-7 | Reserved |

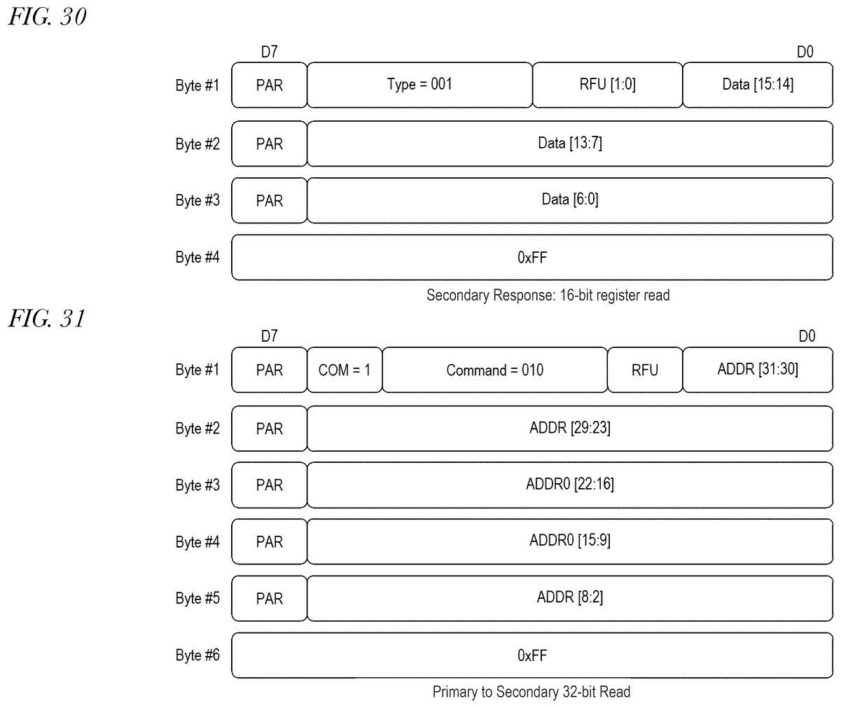

FIG. 29 is an example block diagram illustrating a primary to secondary 16-bit register read command packet in accordance with embodiments of the present disclosure. The primary device may request a 16-bit register read by sending a 16-bit register read command with the COM bit set to 1 followed by three bytes with the register address, as shown. The 16-bit register read command packet may be used to read secondary device and link status, as well as other data such as voltage and temperature measurements. Once the secondary device receives the 16-bit register read command, the secondary device will respond with a 4-byte secondary response packet, an example block diagram of which is shown in FIG. 30, that includes data and a type field to indicate to the primary device the type of response.

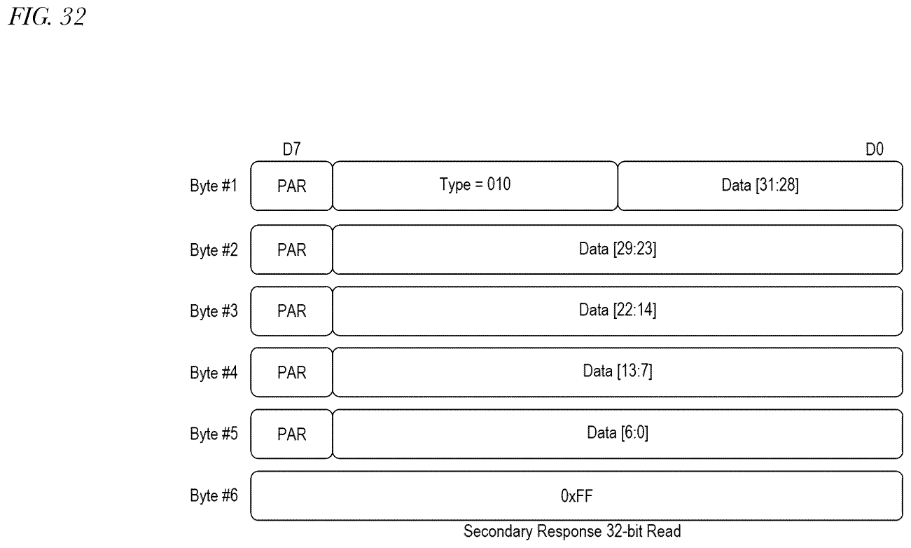

FIG. 31 is an example block diagram illustrating a primary to secondary 32-bit register read command packet in accordance with embodiments of the present disclosure. The primary device may request to read any secondary device register or memory location by sending a 32-bit register read command with the COM bit set to 1 followed by five bytes with the register address, as shown. Once the secondary device receives the 32-bit register read command, the secondary device responds back with a 6-byte secondary response packet, an example block diagram of which is shown in FIG. 32, that includes data and a type field to indicate to the primary device the type of response.

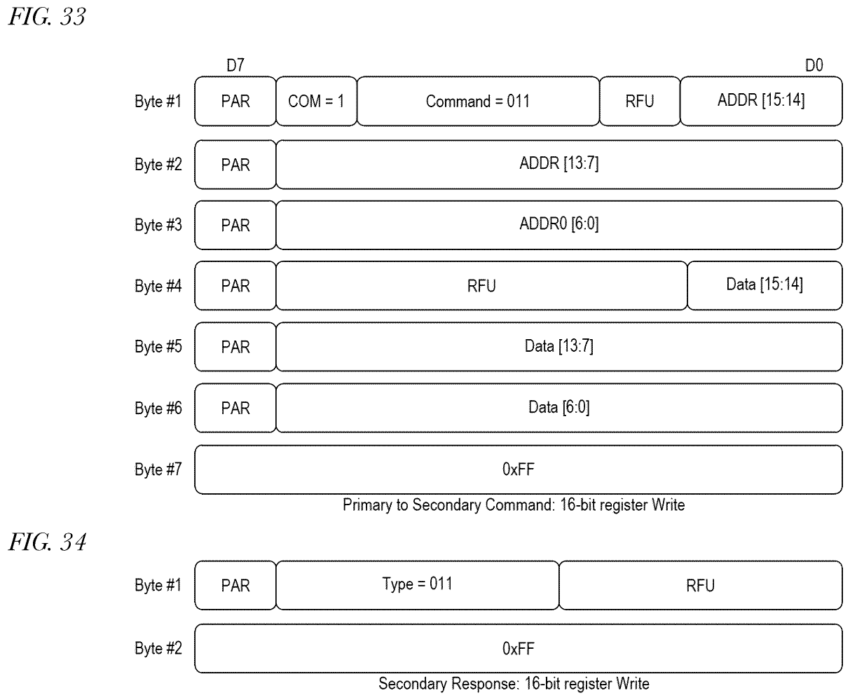

FIG. 33 is an example block diagram illustrating a primary to secondary 16-bit register write command packet in accordance with embodiments of the present disclosure. The primary device may request a 16-bit register write by sending a 16-bit register write command with the COM bit set to 1 followed by a 16-bit address, as shown. Once the write command is received, the secondary device responds with a two-byte ACK packet, an example block diagram of which is shown in FIG. 34, to indicate that the write was successful.

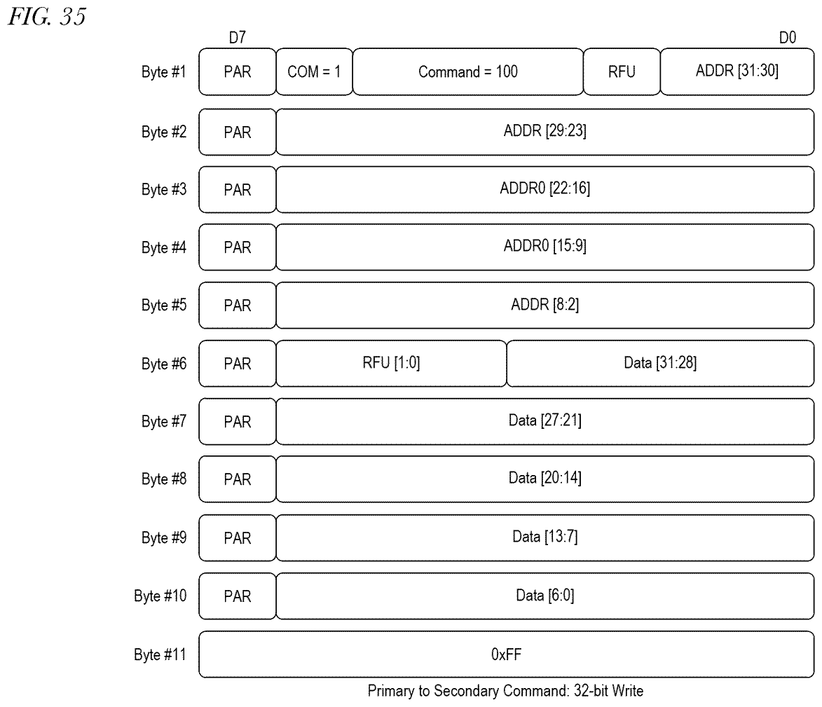

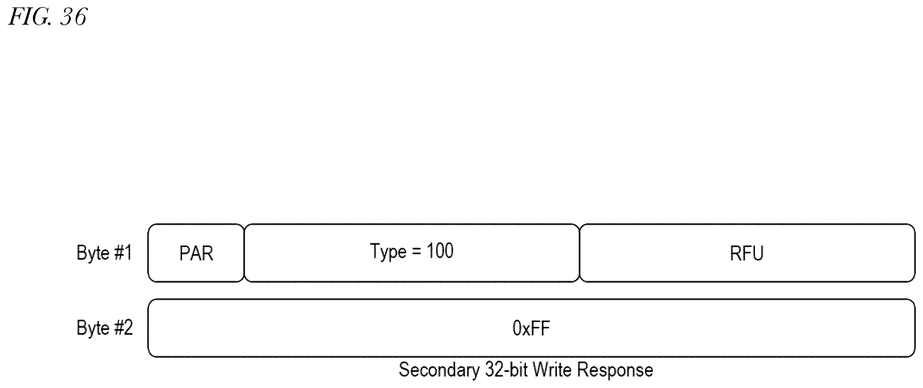

FIG. 35 is an example block diagram illustrating a primary to secondary 32-bit register write command packet in accordance with embodiments of the present disclosure. The primary device may request a 32-bit register or memory write by sending a 32-bit register write command with the COM bit set to 1 followed by a 32-bit address and followed by 32-bit write data, as shown. Once the write command is received, the secondary device responds with a two-byte ACK packet, an example block diagram of which is shown in FIG. 36, to indicate that the write was successful.

In one embodiment, the host processor may configure and control the secondary camera controller device by “tunneling” through the primary camera controller device to the secondary camera controller device. The host processor may accomplish the tunneling as follows. The host processor may send a command to the primary camera controller device to write a register/memory of the secondary camera controller device; in response, the primary camera controller device sends one or more register/memory write packets to the secondary camera controller device based on the command received from the host processor. Additionally, the host processor may send a command to the primary camera controller device to read a register/memory of the secondary camera controller device; in response, the primary camera controller device sends one or more register/memory read packets to the secondary camera controller device based on the command received from the host processor; the primary camera controller device receives from the secondary camera controller device the data in register/memory and returns the received data to the host processor.

Although embodiments have been described for use in controlling actuators that are voice coil motors of a camera, other embodiments are contemplated in which the primary/secondary device combination is used to control other types of actuators, e.g., stepper motors, piezo-electric motors, and the system may be viewed as an expression of a servo loop for performing the various functions described above. Additionally, various types of sensors may be employed to provide the sensor data, e.g., Hall sensors or other type of magnetic sensors may provide position data, and various temperature detection devices may be employed to provide temperature data. Finally, although embodiments are described in which the communication link may be a UART type communication link, other embodiments are contemplated in which other types of communication links between the primary camera controller device and the secondary camera controller devices are used, such as a point-to-point RS232 asynchronous serial link, a multi-drop RS485 asynchronous serial link, an Inter-Integrated Circuit (I2C) multi-drop synchronous link, an Serial Peripheral Interface (SPI) multi-drop synchronous link, an Ethernet link, a Universal Serial Bus (USB) link, an High-Definition Multi-Media Interface (HDMI) link, and a Fiber Channel link.

### Un-Synchronized On-Demand Remote Sensing and Remote Actuation

Embodiments are described above of control systems that perform remote sensing and remote actuation. That is, the control systems include a primary (or local) camera controller device (CCD) that inputs position sensor samples of a lens/image sensor and processes the samples to generate control data to output to actuators (e.g., voice coil motors) to move and/or keep the lens/image sensor to/at a desired position (e.g., specified by a host processor). Because the number of sensor inputs and/or control outputs of a single CCD—which is a package, chip, or integrated circuit—is insufficient for some applications, the systems also include a secondary (or remote) CCD coupled to the primary CCD by a communication link in order to increase the total number of sensor inputs and/or control outputs. The inputting of the secondary sensor samples by the secondary/remote CCD for use in producing the control data may be referred to generally as remote sensing. The outputting of secondary control data to secondary actuators by the secondary CCD may be referred to generally as remote actuation.

Remote sensing and remote actuation embodiments are described above in which clock sources of the primary and secondary CCDs are synchronized such that control loop frames (also referred to as DSP frames), sensor data sampling, and control outputs are synchronized between the local and remote CCDs. However, there may be costs associated with solutions such as those described above or with other clock synchronized solutions in terms of material cost and/or performance cost, e.g., wasted DSP bandwidth, the addition of pins to the packages/chips/integrated circuits that may already be pin-constrained, or the addition of other hardware (such as the circuitry of FIG. 14) which may already be constrained. Other costs may be increased delays to system startup due to the latencies involved in achieving synchronization and an overall increase in the complexity of design in order to incorporate into end products which may delay both of their times to market. Yet another cost may be increased power consumption/dissipation, which may require more frequent recharge cycles and result in reduction of battery life, and which may compound thermal considerations in end product designs. Finally, there may be costs associated with the loss of synchronization after initial achievement thereof, which may necessitate recovery from the pathological unsynchronized state that may result in interruptions to performance and degradation in the usability of the end product. More specifically, detection of loss of synchronization may require a balance of (a) tolerance to some loss of synchronization and hence deviation from desired performance levels and (b) higher frequency of re-synchronization. Remote sensing embodiments are now described in which the primary and secondary CCD clock sources may be unsynchronized and therefore enjoy cost advantages.

Two characteristics of a control system are in view. One characteristic is the staleness of the samples used to generate the control data. In the case of a group of samples that are decimated to generate a single control data, e.g., in the case of over-sampling, the staleness may be referred to as group delay. The staleness/group delay refers to the time delay between the time the samples are sensed and the time the samples are processed to generate the control data. In order for the control system to achieve acceptable performance in controlling the lens/image sensor in a given application, there may be a requirement that the staleness/group delay needs to be below a threshold. Another characteristic is the time-alignment of the sensor samples, which refers to the time delay between the time the samples are sensed and the time the control data is driven to the actuators. In the case of a remote sensing system, the time-alignment of the primary CCD may be different than the time-alignment of the secondary CCD. More precisely, in a remote sensing system, the characteristic of the difference between the time-alignments of the primary and secondary CCDs may be required to be below a threshold in order for the control system to achieve acceptable performance in controlling the lens/image sensor in a given application. In a remote sensing system, control loop latency may be used to refer to the time delay between the time of the gathering of the earliest information of all the information processed by the control loop to generate the actuation data—which may be the earliest of the time the primary samples are sensed and the time the secondary samples are sensed—and the time the actuators are driven with the control data generated using the processed information, which includes the primary and secondary samples. Generally, the control loop latency must be less than a delay margin in order to achieve a stable control loop.

Three embodiments of unsynchronized remote sensing are described in which the primary CCD sends a demand for secondary position sensor information to the secondary CCD over the communication link, and the secondary CCD (e.g., operating in an open loop mode) produces the secondary position sensor information by decimating its youngest group of samples relative to the demand and sends the secondary position sensor information back over the communication link to the primary CCD. The primary CCD sends the demand at an offset within its current control loop period such that the secondary position sensor information arrives at the primary CCD just in time before the next control loop period starts, and the primary CCD processes the secondary position sensor information along with primary position sensor information to generate the control data, thus minimizing staleness/group delay with respect to the secondary position samples within the constraint of the round-trip latency to communicate over the communication link. Stated alternatively, the primary CCD times the preparation and sending of the demand to the secondary CCD such that the secondary position sensor information arrives back at the primary CCD as close as possible to the start of the control loop processing of the primary and secondary position sensor information in the next control loop period, which minimizes the control loop latency with respect to the secondary position sensor information given the constraints that the secondary CCD is performing remote sensing and the clock sources on the primary and secondary CCDs are not synchronized. The three embodiments may provide different primary sample group delay and primary-secondary time-alignment difference characteristics.

In the first embodiment, the primary CCD decimates a group of the primary position samples that are most closely aligned with the group of decimated secondary position samples so that the primary-secondary time-alignment difference is minimized given the constraint that the primary and secondary CCDs have unsynchronized clock sources, e.g., to approximately within a largest of the primary and secondary position sensor sample periods. In an embodiment, the primary CCD software (e.g., a DSP) decimates the youngest primary position samples with respect to expiration of a timer whose delay from the beginning of the current control loop period causes the primary CCD to decimate its samples at approximately the same time as the secondary CCD. In an alternate embodiment, each time the primary CCD senses the primary position sensors to obtain another primary position sample (i.e. for each position sensor), dedicated hardware of the primary CCD decimates the youngest primary position samples (i.e., including the primary sample just obtained) to produce a current primary position sensor information instance; in response to expiration of the timer, the primary CCD stores the current primary position sensor information instance; and, along with the subsequently received secondary position sensor information, the primary CCD processes the stored primary position sensor information to generate the control data. In an embodiment, the dedicated hardware may perform the decimation as a moving average of the youngest primary position samples. The first embodiment enjoys a minimized primary-secondary time-alignment difference in exchange for a larger primary group delay than the third embodiment.

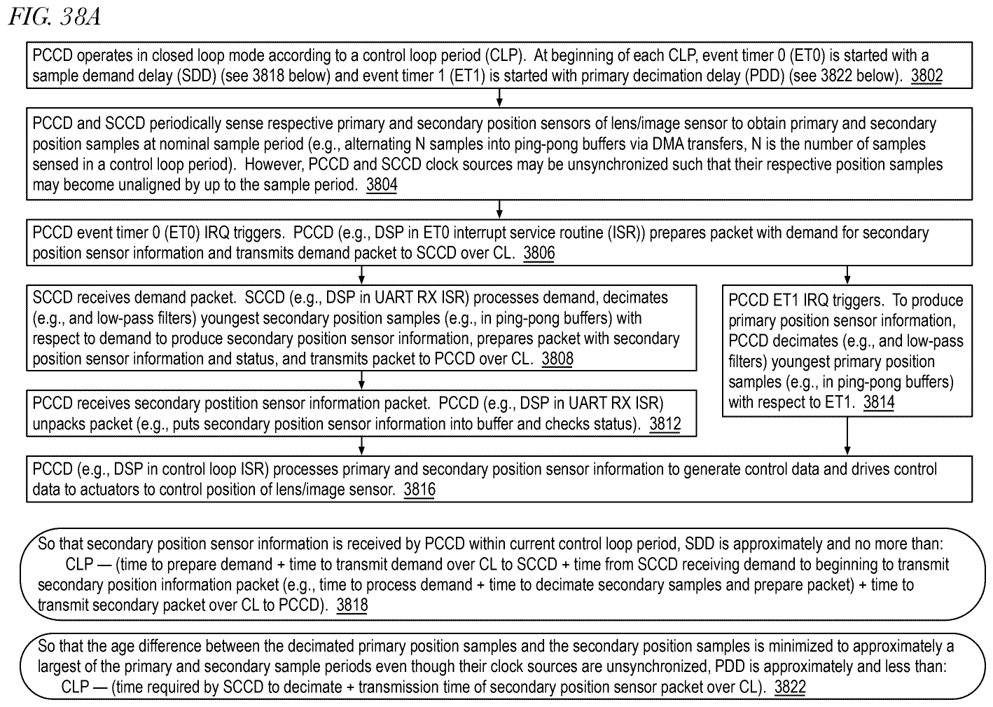

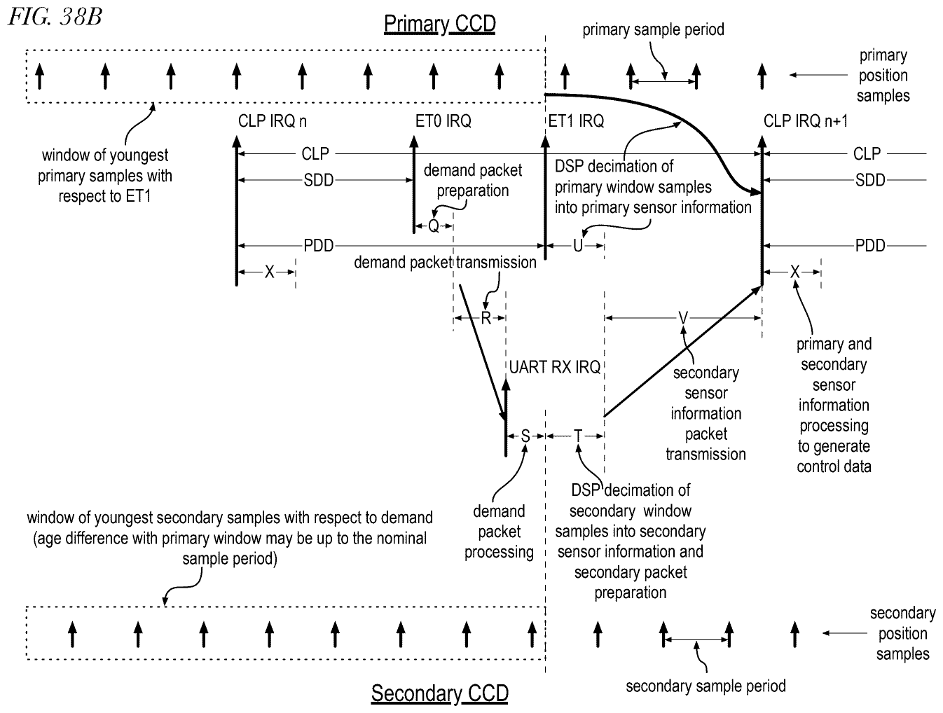

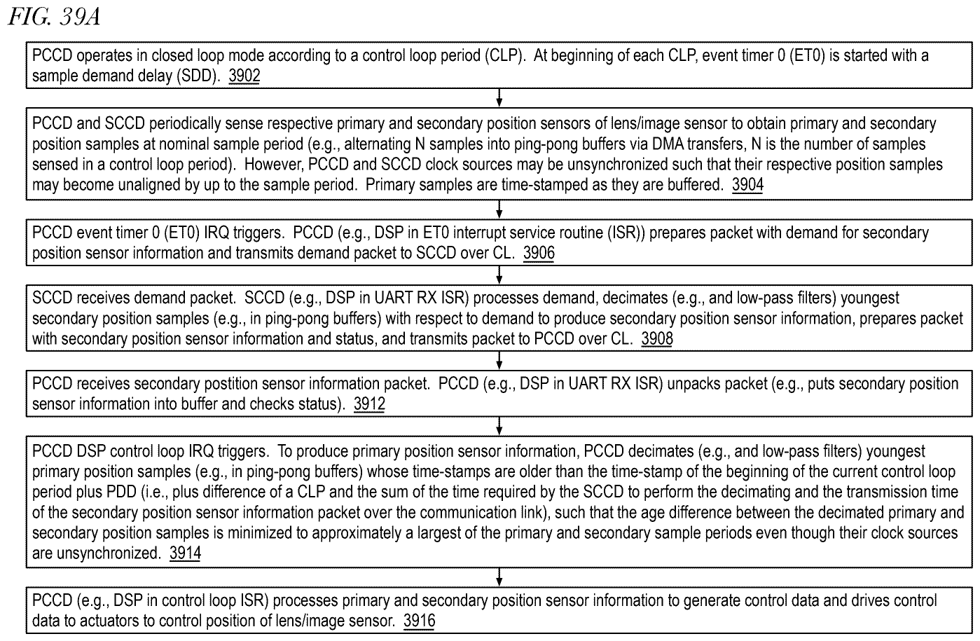

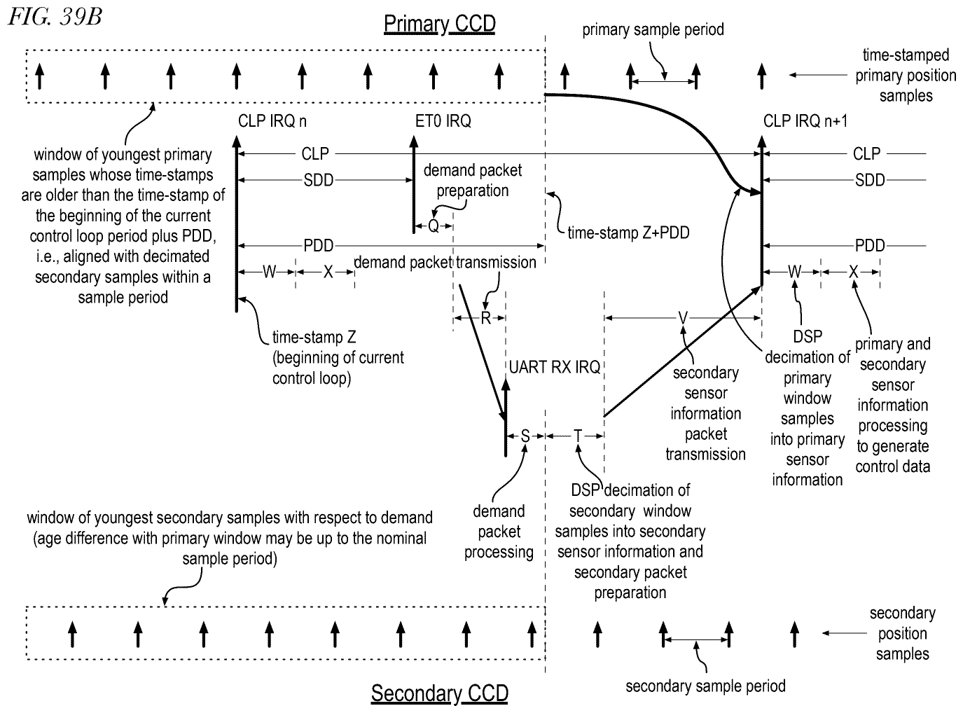

In the second embodiment, the primary CCD employs time-stamping. In an embodiment, the primary samples are time-stamped within a buffer that receives them, and the primary CCD performs software decimation at the beginning of the next control loop period; the primary CCD uses the time-stamps to select the samples in the buffer that are time-aligned (e.g., to within approximately a largest of the primary and secondary sample periods) with the decimated secondary samples. In an alternate embodiment that employs the dedicated hardware, each current primary position sensor information instance is buffered and time-stamped; and to generate the control data, the primary CCD processes, along with the received secondary position sensor information, the youngest current primary position sensor information instance from the buffer that has a time-stamp that is older than a predetermined time offset from the beginning of the current control loop period such that the primary-secondary time-alignment difference is minimized. Similarly to the first embodiment, the second embodiment enjoys a minimized primary-secondary time-alignment difference in exchange for a larger primary group delay than the third embodiment. The second embodiment does not involve the timer employed in the first embodiment (e.g., ET1 of FIG. 38B) which may be an advantage over the first embodiment. In the software decimation embodiment, the advantage over the first embodiment may be enjoyed in exchange for a relatively small addition (e.g., time W of FIG. 39B, which may be on the order of a few microseconds in one embodiment) to the control loop latency relative to the first embodiment. Additionally, the software decimation embodiments of the first and second embodiments incur the primary DSP processing bandwidth within different control loop periods, or viewed alternatively, within different locations of a control loop period.

In the third embodiment, dedicated hardware on the primary CCD decimates the primary samples that are youngest with respect to the beginning of the next control loop period. The third embodiment enjoys a minimized primary group delay in exchange for a larger primary-secondary time-alignment difference than the first and second embodiments. The third embodiment has the additional advantage of requiring less primary DSP processing bandwidth than the software decimation embodiments of the first and second embodiments because the dedicated hardware on the primary CCD decimates the primary samples. In an embodiment, a CCD decimates the samples by averaging them, whereas in other embodiments the CCD decimates the samples by employing other types of filtering on the samples. Embodiments are also described in which the unsynchronized on-demand remote sensing systems also perform remote actuation.

In an embodiment, in response to the demand, a processor (e.g., DSP) of the secondary CCD decimates the youngest secondary position samples to produce the secondary position sensor information to be sent to the primary CCD over the communication link. In an alternate embodiment, each time the secondary CCD senses the secondary position sensors to obtain another secondary position sample, dedicated hardware of the secondary CCD decimates the youngest secondary position samples (i.e., including the secondary sample just obtained) to produce a current secondary position sensor information instance. In the alternate embodiment, in response to the demand, rather than performing software decimation, the secondary CCD simply sends the current secondary position sensor information instance to the primary CCD.

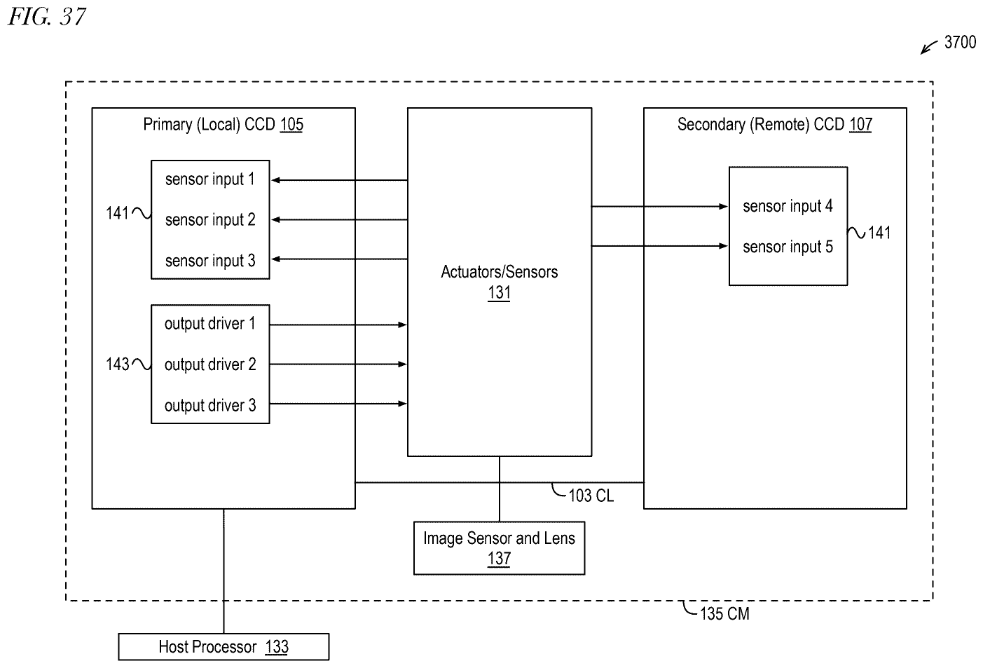

FIG. 37 is an example block diagram illustrating a system 3700 configured to perform unsynchronized on-demand remote sensing in accordance with embodiments of the present disclosure. The system 3700 includes a camera module 135 (e.g., camera module 135 of FIGS. 10, 15, and/or 17) for controlling a camera lens/image sensor 137 (e.g., element 137 of FIGS. 10, 15, and/or 17). The camera module 135 also includes a primary camera controller device (PCCD) 105 (e.g., package/integrated circuit/chip 105 of FIGS. 10, 15, and/or 17), also referred to as the local CCD. The camera module 135 also includes a secondary camera controller device (SCCD) 107 (e.g., package/integrated circuit/chip 107 of FIGS. 10, 15, and/or 17), also referred to as a remote CCD, that communicates with the PCCD 105 via a communication link 103 (e.g., communication link 103 of FIGS. 10, 15, and/or 17). A host processor 133 (e.g., host processor 133 of FIGS. 10, 15, and/or 17) controls the camera module 135 via the PCCD 105. The PCCD 105 and the SCCD 107 include position sensor inputs 141 (e.g., position sensor inputs 141 of FIGS. 10, 15 and/or 17) that obtain respective primary and secondary position samples sensed from position sensors 131 (e.g., position sensors 131 of FIGS. 10, 15, and/or 17). In the embodiment of FIG. 37, the PCCD 105 includes three sensor inputs referred to as sensor input 1, sensor input 2, and sensor input 3, and the SCCD 107 includes two sensor inputs referred to as sensor input 4 and sensor input 5. However, other embodiments are contemplated in which the number of sensor inputs 141 is different than five. The PCCD 105 includes output drivers 143 that drive control data to actuators 131 (e.g., actuators 131 of FIGS. 10, 15, and/or 17). In the embodiment of FIG. 37, the PCCD 105 includes three output drivers 143 denoted output driver 1, output driver 2, and output driver 3. However, other embodiments are contemplated in which the number of output drivers 143 of the PCCD 105 is different than three. In some embodiments the primary and secondary CCDs perform half-duplex communication over a single-wire communication link 103 (e.g., as shown in FIGS. 10 and 15), in other embodiments the primary and secondary CCDs perform full-duplex communication over a two-wire communication link 103 (e.g., as shown in FIG. 17) by communicating in simplex in opposite directions, and in other embodiments the primary and secondary CCDs perform full-duplex communication over a single-wire communication link 103 (e.g., as shown in FIGS. 10 and 15), e.g., using two carrier frequencies.

FIGS. 38A and 38B, 39A and 39B, and 40A and 40B describe respective first, second, and third embodiments of unsynchronized on-demand remote sensing operation by the system 3700 of FIG. 37.

FIG. 38A is an example flowchart illustrating unsynchronized on-demand remote sensing by a system (e.g., system 3700 of FIG. 37) in accordance with a first embodiment of the present disclosure. Operation begins at block 3802.

At block 3802, the PCCD operates in a closed loop mode (e.g., a control loop) according to a control loop period (CLP). A control loop period may also be referred to as a DSP loop period. In an embodiment, a control loop timer is started (e.g., by a DSP of the PCCD) with a delay equal to the CLP, an interrupt request (IRQ) to the DSP is generated when the timer expires, and the timer's interrupt service routine (ISR) restarts the timer with another delay equal to the CLP. In an embodiment, a CLP is 100 microseconds (i.e., 10 kHz), although other embodiments are contemplated in which the CLP is a different value, e.g., 62.5 microseconds (i.e., 16 kHz) or 50 microseconds (i.e., 20 kHz). At the beginning of each control loop period, an event timer 0 (ET0) is started with a sample demand delay (SDD). An IRQ to the DSP is generated at expiration of ET0. The value of SDD is described with respect to information block 3818. Additionally at the beginning of each control loop period, an event timer 1 (ET1) is started with a primary decimation delay (PDD). An IRQ to the DSP is generated at expiration of ET1. The value of PDD is described with respect to information block 3822. Operation proceeds to block 3804.

At block 3804, the PCCD and the SCCD continually and periodically sense from respective primary and secondary position sensors of the lens/image sensor to obtain respective primary and secondary position samples at respective primary and secondary sample periods. For example, with respect to FIG. 37, the PCCD continually and periodically senses from three primary position sensors 131 via the three primary sensor inputs (e.g., sensor input 1, sensor input 2, and sensor input 3), and the SCCD continually and periodically senses from two secondary position sensors 131 via the two secondary sensor inputs (e.g., sensor input 4 and sensor input 5). The clock sources of the PCCD and the secondary CCD are not necessarily synchronized. As a result of the fact that the primary and secondary clock sources are unsynchronized, the primary and secondary position samples may become unsynchronized by up to the largest of the primary and secondary sample periods. Advantageously, according to the described embodiments, the PCCD and the SCCD need not have synchronized control loop periods to accomplish remote sensing by the SCCD (the SCCD may operate in an open loop mode), and the sample period misalignment between the PCCD and the SCCD has been found to be acceptable in various applications of the system. In an embodiment, each of the PCCD and the SCCD includes a ping buffer and a pong buffer, and each buffer is capable of receiving N position samples, where N is the number of samples sensed in a CLP. Each CCD alternates between sensing N samples into the ping buffer, then sensing N samples into the pong buffer, then sensing N samples into the ping buffer, and so forth. In an embodiment, a direct memory access (DMA) controller (DMAC) performs the transfers into the buffers. In an embodiment, a DMA interrupt request to the DSP of the CCD is generated upon transfer of the Nth sample. In response (e.g., the DMAC ISR), the DSP updates buffer descriptors for the DMAC to cause alternation of the next N samples into the other buffer. Operation proceeds to block 3806.

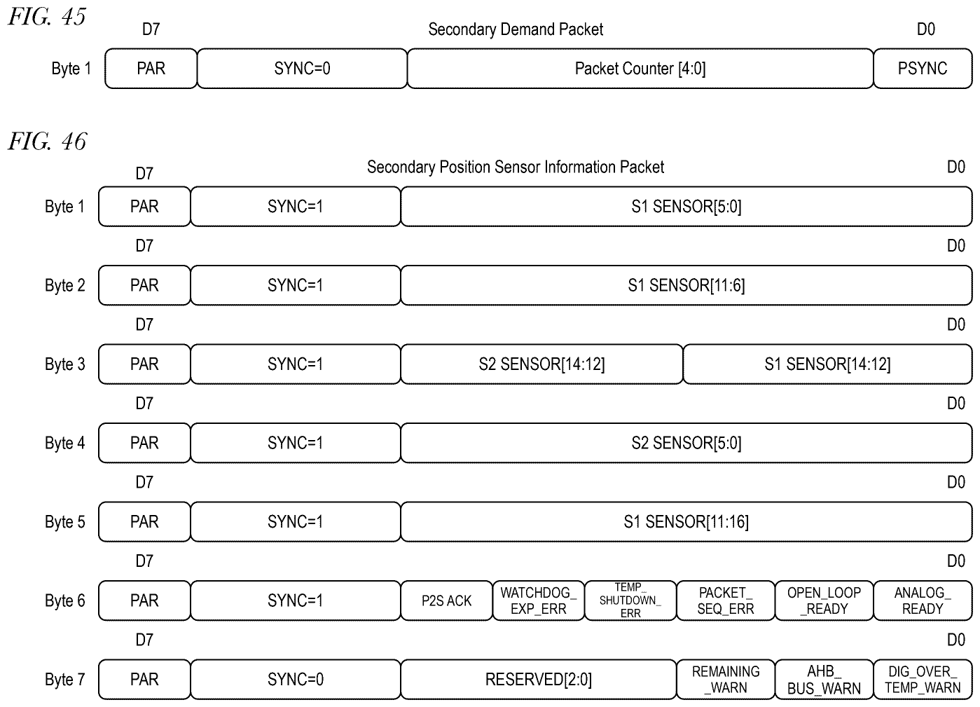

At block 3806, during a current control loop period, the ET0 IRQ triggers on the PCCD. The PCCD (e.g., the ET0 ISR running on the DSP) prepares a demand packet that requests secondary position sensor information from the SCCD. The PCCD then transmits the demand packet to the SCCD over the CL. An example of the demand packet according to an embodiment is illustrated in FIG. 45. Operation proceeds from block 3806 to block 3808 and to block 3814.

At block 3808, the SCCD receives the demand packet from the PCCD. In response, the SCCD (e.g., a UART RX ISR running on the DSP of the SCCD) processes the demand packet and decimates and low-pass filters (LPF) the youngest secondary position samples with respect to the demand to produce secondary position sensor information. In an embodiment, the youngest secondary samples are in and may span the SCCD ping-pong buffers. For example, in an embodiment in which the number N of samples per CLP is eight, six of the samples may be in the ping buffer and two may be in the pong buffer. The SCCD then prepares a secondary position sensor information packet and transmits the packet to the PCCD over the CL. An example of the secondary position sensor information packet according to an embodiment is illustrated in FIG. 46. In an alternate embodiment, each time the secondary CCD senses the secondary position sensors to obtain another secondary position sample, dedicated hardware of the secondary CCD (e.g., not the secondary DSP) decimates (and LPFs) the youngest secondary position samples to produce a current secondary position sensor information instance; and in response to the demand, the secondary CCD reads the current secondary position sensor information instance and uses it to prepare the secondary position sensor information packet. In an embodiment, the dedicated hardware may perform the decimation as a moving average of the youngest secondary position samples. Operation proceeds to block 3812.

At block 3812, the PCCD receives the secondary position sensor information packet. In response, the PCCD (e.g., a UART RX ISR running on the DSP of the PCCD) processes, or unpacks, the secondary position sensor information packet. For example, the PCCD puts the secondary position sensor information into a buffer and checks the status provided in the packet to verify that there are no errors associated with the secondary position sensor information received in the packet. Operation proceeds to block 3816.

At block 3814, the ET1 IRQ triggers on the PCCD. The PCCD (e.g., the ET1 ISR running on the DSP) decimates and low-pass filters (LPF) the youngest primary position samples with respect to the ET1 to produce primary position sensor information. In an embodiment, the youngest primary samples are in and may span the PCCD ping-pong buffers. In an alternate embodiment, each time the primary CCD senses the primary position sensors to obtain another primary position sample, dedicated hardware of the primary CCD (e.g., not the primary DSP) decimates (and LPFs) the youngest primary position samples to produce a current primary position sensor information instance; and in response to the expiration of ET1, the primary CCD stores the current primary position sensor information for subsequent processing (e.g., at block 3816). Operation proceeds to block 3816.

At block 3816, the PCCD (e.g., a control loop ISR running on the DSP of the PCCD) processes the primary and secondary position sensor information (e.g., performs mathematical control loop computations on the position sensor information) to generate control data and drives the control data to actuators to control the position of the lens/image sensor. For example, with respect to FIG. 37, the PCCD drives the control data to three actuators 131 via the three output drivers (e.g., output driver 1, output driver 2, and output driver 3). In an embodiment, a hardware pickup occurs on the PCCD that drives the primary portion of the control data, e.g., similar to the manner described with respect to FIG. 9.

The primary and secondary CCDs each include a clock source that is used to provide clocks to the circuits of the CCD, such as the DSP (including the timers), the circuitry that periodically senses the position sensors, and the communication link circuitry. The primary and secondary CCD clock sources are designed to have the same nominal clock frequency; however, the actual primary and secondary clock frequencies may be slightly different in a given system. Furthermore, one or both of their clock frequencies may drift over time, e.g., due to aging and/or due to temperature variations during operation. The fact that the primary and secondary CCD clock sources are unsynchronized may have the following effects.

The primary and secondary clock frequency differences may cause the primary and secondary processors (e.g., DSPs) to operate at slightly different rates from their nominal rate, which may cause the execution time of a given software routine to vary slightly from their nominal execution times as the clock frequency varies and/or may cause the delay associated with their timers to vary slightly from their nominal delays as the clock frequency varies, for example. For example, a DSP operating at 500 MHz may take a certain number of microseconds to execute a routine, e.g., to prepare the demand, process the demand, software decimate samples. However, if during a given time the actual operating frequency of the DSP is 505 MHz, for example, the execution time may be one percent shorter to perform the operation. Hence, in the present embodiments, various predetermined times, such as durations Q, S, T, and U, which are described with respect to FIGS. 38A, 38B, 39A, 39B, 40A, and 40B, for example, are predetermined based on the worst-case variations of the clock source frequencies.

Additionally, the transmission time of a packet on the communication link may vary slightly as the clock frequency varies. In an embodiment, variation in the primary clock frequency affects the transmission time of the demand to the SCCD, and variation in the secondary clock frequency affects the transmission time of the secondary position sensor information packet to the PCCD. Hence, in the present embodiments, various predetermined times, such as durations R and V, which are described with respect to FIGS. 38A, 38B, 39A, 39B, 40A, and 40B, for example, are predetermined based on the worst-case variations of the clock source frequencies.

Still further, variation in the primary clock frequency affects the primary sample period at which the primary position sensors are sensed to obtain the primary samples, and variation in the secondary clock frequency affects the secondary sample period at which the secondary position sensors are sensed to obtain the secondary samples. Hence, the fact that the primary and secondary clock sources are unsynchronized may cause the primary and secondary position sensors to be sampled at slightly different sampling frequencies, which may in turn result in an unalignment of the primary and secondary position samples. More specifically, in the worst case, two corresponding primary and secondary samples may be sensed up to a sample period apart. More precisely, an age of two corresponding primary and secondary samples may be up to the largest of the primary and secondary sample periods. For example, assume a nominal sample period of 12.5 microseconds. Further assume the actual primary and secondary sample periods are 12.49 and 12.51 microseconds, respectively, during a given time window in which groups of primary and secondary position samples associated with a given control loop period are obtained for decimation. Further assume the edges of the respective signals that cause the primary and secondary position sensors to be sampled have drifted apart such that they reach their maximum non-alignment. In such case, two corresponding primary and secondary samples (e.g., the youngest samples) of the group may be unaligned by up to 12.51 microseconds.

As described in information block 3818, the value of delay SDD is predetermined and is approximately and no more than a CLP minus a sum of the following predetermined times:
(1) a first predetermined time for the PCCD to prepare the demand packet (illustrated as duration Q in FIG. 38B);
(2) a second predetermined time to transmit the demand packet over the CL to the SCCD (illustrated as duration R in FIG. 38B);
(3) a third predetermined time from the SCCD receiving the demand to the SCCD beginning to transmit the secondary position sensor information packet, which may be the sum of the time required by the SCCD to process the demand (illustrated as duration S in FIG. 38B) and the time required by the SCCD to decimate the youngest secondary position samples to produce the secondary position sensor information (or in the alternate embodiment to read the current secondary position sensor information instance produced by the dedicated hardware) and prepare the secondary position sensor information packet (illustrated as duration T in FIG. 38B); and
(4) a fourth predetermined time to transmit the secondary position sensor information packet over the CL to the PCCD (illustrated as duration V in FIG. 38B).

The SDD value is predetermined, based on the worst-case variations of the clock source frequencies, to cause the secondary position sensor information packet to arrive at the PCCD as close as possible to the end of, yet within, the current control loop period and just in time for processing during the next control loop period. In an embodiment, the SDD value is predetermined as follows.

The execution time of the routine that prepares the demand packet, e.g., duration Q, is predetermined based on a clock source of the primary CCD. Furthermore, to foster consistency of duration Q, in an embodiment, event timer 0 ISR immediately runs in response to the event timer 0 IRQ, e.g., the event timer 0 IRQ is the highest priority IRQ to the DSP and/or the ISRs of any higher priority IRQs in the system are designed such that they are not running when the event timer 0 IRQ occurs.

The time to transmit the demand packet over the communication link to the SCCD, e.g., duration R, is predetermined based on a clock source of the primary CCD.

The execution time of the routines that process the demand packet, e.g., duration S, and that decimate the secondary samples to generate the secondary position sensor information (or in the alternate embodiment to read the current secondary position sensor information instance produced by the dedicated hardware) and produce the secondary position sensor information packet, e.g., duration T, is predetermined based on the worst-case difference between the primary and secondary clock frequency of the secondary processor, more specifically, when the secondary clock frequency is the slower of the two clock frequencies. Furthermore, to foster consistency of durations S and T, in an embodiment, the SCCD UART RX ISR immediately runs in response to the UART RX IRQ, e.g., the UART RX IRQ is the highest priority IRQ to the DSP and/or the ISRs of any higher priority IRQs in the system are designed such that they are not running when the UART RX IRQ occurs.

The time to transmit the secondary position sensor information packet over the communication link to the PCCD, e.g., duration V, is predetermined based on the worst-case difference between the primary and secondary clock frequency of the secondary processor, more specifically, when the secondary clock frequency is the slower of the two clock frequencies.

The CLP, for the purpose of predetermining the SDD, is based on a clock source of the primary CCD.

As described in information block 3822, the value of the PDD is predetermined and is approximately and no greater than a CLP minus a sum of the time required by the SCCD to decimate the youngest secondary position samples to produce the secondary position sensor information (or in the alternate embodiment to read the current secondary position sensor information instance produced by the dedicated hardware) and prepare the secondary position sensor information packet (e.g., duration T in FIG. 38B) and the time to transmit the secondary position sensor information packet over the CL to the PCCD (e.g., duration V in FIG. 38B). Similar to the SDD, the PDD value is predetermined, based on the worst-case variations of the clock source frequencies, to cause the age difference between the primary and secondary position samples selected for decimation to be minimized and approximately no greater than the largest of the primary and secondary sample periods even though the PCCD and SCCD clock sources are unsynchronized.

FIG. 38B is an example timing diagram illustrating unsynchronized on-demand remote sensing in accordance with the first embodiment of the present disclosure. In FIG. 38B, time flows from left to right. At the top of FIG. 38B, events and durations are shown with respect to the PCCD, and at the bottom of FIG. 38B events and durations are shown with respect to the SCCD. At the top a sequence of primary position samples are indicated by upward pointing arrows sampled according to the shown primary sample period, and at the bottom a sequence of primary position samples are indicated also by upward pointing arrows (e.g., as described with respect to block 3804 of FIG. 38A) sampled according to the shown secondary sample period. Because the primary and secondary clock sources are unsynchronized, the clock edges of the PCCD and SCCD that cause the position sensors to be sensed may become unaligned over time, as shown in FIG. 38B. In FIG. 38B, twelve primary position samples and twelve secondary position samples are shown. Although the PCCD takes samples from multiple primary sensors per sample period (e.g., from three different position sensors in the example embodiment of FIG. 37), a single upward pointing arrow is intended to indicate a sample from all of the primary position sensors; and although the SCCD takes samples from multiple secondary sensors per sample period (e.g., from two different position sensors in the example embodiment of FIG. 37), a single upward pointing arrow is intended to indicate a sample from all of the secondary position sensors.

A current CLP of the PCCD is shown between a first CLP IRQ denoted n that begins the current CLP and a second CLP IRQ denoted n+1 that begins the next CLP, e.g., as described with respect to block 3802 of FIG. 38A. An ET0 IRQ is shown a delay of SDD after the CLP IRQ n, e.g., as described with respect to block 3802 of FIG. 38A. An ET1 IRQ is shown after a delay of PDD after the CLP IRQ n, e.g., as described with respect to block 3802 of FIG. 38A. A window of youngest primary samples with respect to the ET1 IRQ is shown within a first dotted rectangle. That is, the youngest N (e.g., eight) primary samples older than the ET1 IRQ are included in the primary window of samples that are decimated by the PCCD, e.g., as described with respect to block 3814 of FIG. 38A. A window of youngest secondary samples with respect to the demand (e.g., within the processing of the demand packet, as shown in the example of FIG. 38B) is shown within a second dotted rectangle. That is, the youngest N (e.g., eight) secondary samples older than the ET1 IRQ are included in the secondary window of samples that are decimated by the SCCD, e.g., as described with respect to block 3808 of FIG. 38A. As shown, the primary and secondary position samples are unsynchronized in the example of FIG. 38B, and the group of decimated primary and secondary position samples for a given control loop period may exhibit an age difference up to the largest of the primary and secondary sample periods.

After and in response to the ET0 IRQ, the demand packet preparation by the PCCD occurs during a duration shown as Q, e.g., as described with respect to block 3806 of FIG. 38A. After Q, the demand packet transmission on the CL occurs during a duration shown as R, e.g., as described with respect to block 3806 of FIG. 38A. A UART RX IRQ of the SCCD is shown in response to reception of the demand packet by the SCCD, e.g., as described with respect to block 3808 of FIG. 38A.

After and in response to the UART RX IRQ, demand packet processing by the SCCD occurs during a duration shown as S, e.g., as described with respect to block 3808 of FIG. 38A. After S, DSP decimation of the secondary window samples by the SCCD into the secondary position sensor information and preparation of the secondary position sensor information packet occurs during a duration shown as T, e.g., as described with respect to block 3808 of FIG. 38A. Alternatively, during duration T, the SCCD reads the current secondary position sensor information instance that was produced by the dedicated hardware by decimating the window of youngest secondary position samples with respect to the demand shown in FIG. 38B, e.g., as also described with respect to block 3808 of FIG. 38A. After and in response to the ET1 IRQ, DSP decimation of the primary window samples by the PCCD into the primary position sensor information occurs during a duration shown as U, e.g., as described with respect to block 3814 of FIG. 38A. Alternatively (not shown), during duration U, the PCCD reads the current primary position sensor information instance that was produced by the dedicated hardware by decimating the window of youngest primary position samples with respect to ET1 shown in FIG. 38B, e.g., as also described with respect to block 3814 of FIG. 38A. The predetermined PDD causes the ET1 on the PCCD and completion of the demand processing on the SCCD to coincide such that the age difference between the group of decimated primary and secondary samples associated with a given control loop period is approximately no greater than the largest of the primary and secondary sample periods.

After T, the secondary position sensor information packet transmission on the CL occurs during a duration shown as V, e.g., as described with respect to block 3808 of FIG. 38A. After V, the secondary position sensor information packet is received and unpacked by the PCCD, e.g., as described with respect to block 3812 of FIG. 38A (e.g., by a UART RX ISR (not shown in FIG. 38B) of the PCCD in response to reception of the secondary position sensor information packet). Finally, after the CLP IRQ n+1 (i.e., the beginning of the next CLP), processing of the primary and secondary sensor information by the PCCD to generate the control data occurs during a duration shown as X, e.g., as described with respect to block 3816 of FIG. 38A.

FIG. 39A is an example flowchart illustrating unsynchronized on-demand remote sensing by a system (e.g., system 3700 of FIG. 37) in accordance with a second embodiment of the present disclosure. Operation begins at block 3902.

Operation at block 3902 is similar to the operation at block 3802 of FIG. 38A, except that the second embodiment does not employ an ET1. Rather, the second embodiment employs time-stamps as described with respect to block 3904. Operation proceeds to block 3904.

Operation at block 3904 is similar to the operation at block 3804 of FIG. 38A, except that the primary position samples are time-stamped within the buffer with the time at which they were sampled. Alternatively, each time a primary position sample is obtained, the youngest group of primary samples are decimated (and LPFed) by dedicated hardware of the PCCD to produce a current primary position sensor information instance which is buffered and time-stamped. The time-stamps are used to align the window of primary samples for decimation with the window of decimated secondary samples as described with respect to block 3914. Operation proceeds to block 3904.

Operation at block 3906 is similar to the operation at block 3806 of FIG. 38A, operation at block 3908 is similar to the operation at block 3808 of FIG. 38A, and operation at block 3912 is similar to the operation at block 3812 of FIG. 38A. Operation proceeds to block 3914.

At block 3914, the control loop IRQ to the PCCD DSP triggers indicating the beginning of the next control loop. The PCCD (e.g., the control loop ISR running on the DSP) decimates and low-pass filters (LPF) the youngest primary position samples (e.g., in the ping-pong buffers) whose time-stamps are older than the time-stamp of the beginning of the current control loop period plus the PDD (i.e., plus the sum of the predetermined time for the secondary CCD to perform the software decimation and the predetermined transmission time of the secondary position sensor information over the communication link) to produce the primary position sensor information to be processed at block 3916. In an embodiment, the youngest primary samples are in and may span the PCCD ping-pong buffers. Alternatively, the PCCD reads from the buffer the youngest current primary position sensor information instance which has a time-stamp that is older than the time-stamp of the beginning of the current control loop period plus the PDD to be the primary position sensor information to be processed at block 3916. As a result, the age difference between the primary and secondary position samples selected for decimation is no greater than approximately the largest of the primary and secondary sample periods even though their clock sources are unsynchronized. Operation proceeds to block 3916.

Operation at block 3916 is similar to the operation at block 3816 of FIG. 38A.

FIG. 39B is an example timing diagram illustrating unsynchronized on-demand remote sensing in accordance with the second embodiment of the present disclosure. FIG. 39B is similar in many respects to FIG. 38B. However, in FIG. 39B, there is no ET1 IRQ nor duration U. Furthermore, FIG. 39B indicates that the primary position samples are time-stamped. Alternatively (not shown), each buffered current primary position sensor information instance produced by the dedicated hardware is time-stamped. More specifically, the window of primary samples that are decimated are the youngest primary samples whose time-stamps are older than the time-stamp of the beginning of the current control loop period plus the PDD. As a result, the decimated primary samples are aligned with decimated secondary samples within a largest of the primary and secondary sample periods. At the beginning of the next loop period, decimation of the primary window samples by the DSP of the PCCD into the primary position sensor information occurs during a duration shown as W, e.g., as described with respect to block 3914 of FIG. 39A. After W, processing of the primary and secondary sensor information by the PCCD to generate the control data occurs during duration X.

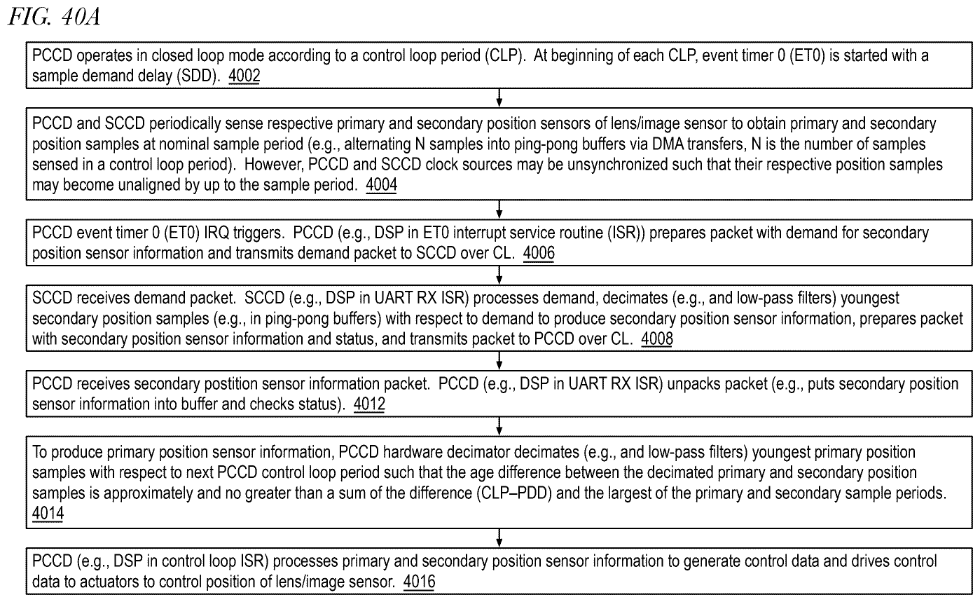

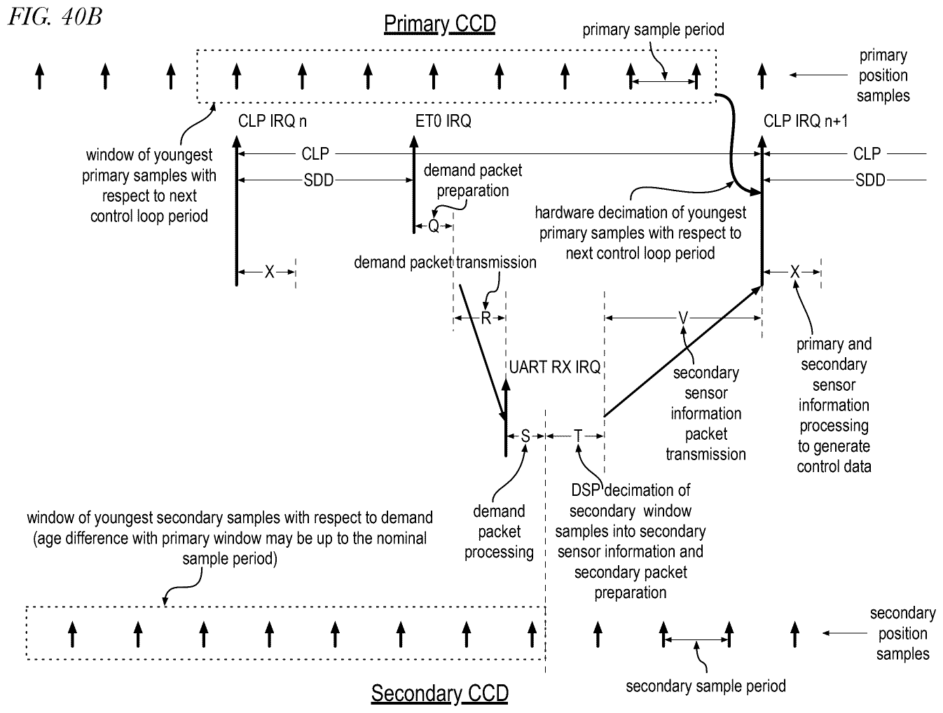

FIG. 40A is an example flowchart illustrating unsynchronized on-demand remote sensing by a system (e.g., system 3700 of FIG. 37) in accordance with a third embodiment of the present disclosure. Operation according to the third embodiment of FIG. 40A is similar in many respects to operation according to the second embodiment of FIG. 39A. However, at block 4004, unlike at block 3904, the primary position samples are not time-stamped. Rather, and furthermore, at block 4014, dedicated hardware (i.e., not the DSP of the PCCD) decimates and low-pass filters (LPF) the youngest primary position samples with respect to the beginning of the next control loop period of the PCCD to produce the primary position sensor information. As a result, the age difference between the primary and secondary position samples selected for decimation is less than the control loop period. In an embodiment, the age difference is approximately and no greater than a sum of the difference (CLP-PDD) and the largest of the primary and secondary sample periods.

FIG. 40B is an example timing diagram illustrating unsynchronized on-demand remote sensing in accordance with the third embodiment of the present disclosure. FIG. 40B is similar in many respects to FIG. 39B. However, in FIG. 40B, no references are made to time-stamps, there is no ET1 IRQ nor durations U, W, and PDD, and duration X (primary and secondary position sensor information processing) occurs at the beginning of the next control loop period as in FIG. 38B. Furthermore, in FIG. 40B, the window of primary samples that are decimated are the youngest primary samples with respect to the beginning of the next control loop period, and their decimation and low-pass filtering is performed by dedicated hardware of the PCCD, as shown. As a result, the decimated primary samples are unaligned with the decimated secondary samples and have an age difference that is less than the control loop period. In an embodiment, the age difference is no greater than a sum of the difference (CLP-PDD) and up to the largest of the primary and secondary sample periods, and the group delay of the decimated primary samples is optimized to within approximately a primary sample period.

Although the third embodiment optimizes the group delay of the primary position samples at the expense of a relatively larger primary-secondary time-alignment difference, and the first and second embodiments optimize the primary-secondary time-alignment difference at the expense of a relatively larger primary group delay, further embodiments are contemplated in which a balance is struck between optimization of the two characteristics. For example, the first and second embodiments may be modified to increase the PDD—i.e., the window of primary samples selected for decimation includes younger samples because the ET1 fires later in the current control loop period (first embodiment) or because the timestamp (e.g., time-stamp Z+PDD in FIG. 39B) against which the primary samples are compared is newer (second embodiment)—such that the primary-secondary time-alignment difference is increased in exchange for the benefit of a corresponding reduction in group delay of the primary position samples. For example, the PDD may be increased by N microseconds to increase the age difference between the primary and secondary position samples by N microseconds in exchange for a decrease in the group delay of the primary position samples by N microseconds. That is, the primary decimation delay may be adjusted to meet the requirements of the application (i.e., the larger system/device) in which the primary-secondary CCD system is employed. Furthermore, the third embodiment may be modified such that the hardware decimation of the youngest primary samples occurs somewhere after duration T but earlier than the end of the current control loop period such that group delay of the primary position samples is increased in exchange for the benefit of a corresponding reduction in the primary-secondary time-alignment difference.

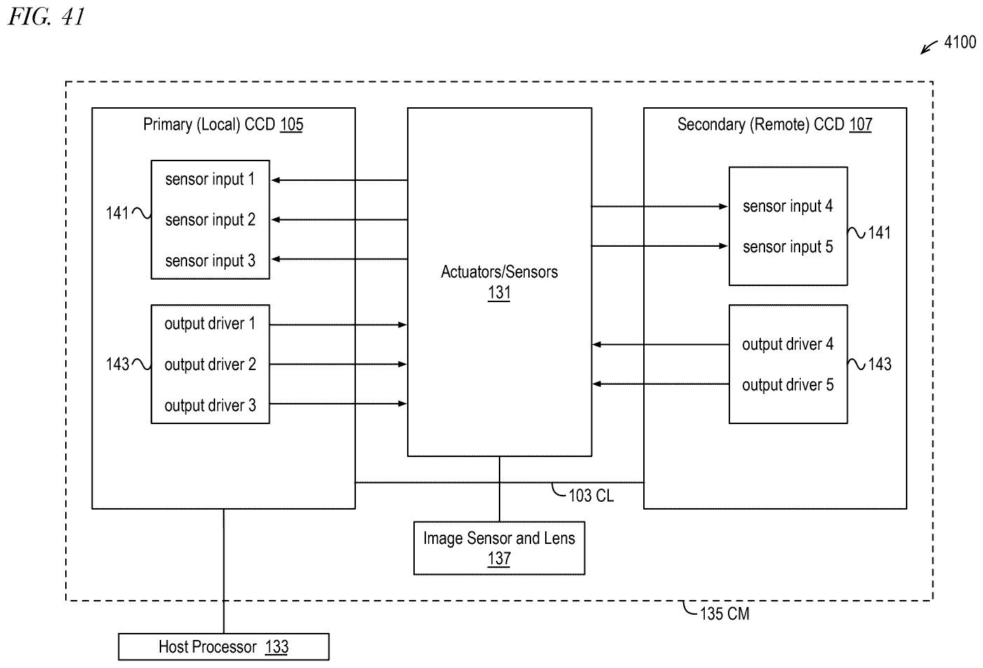

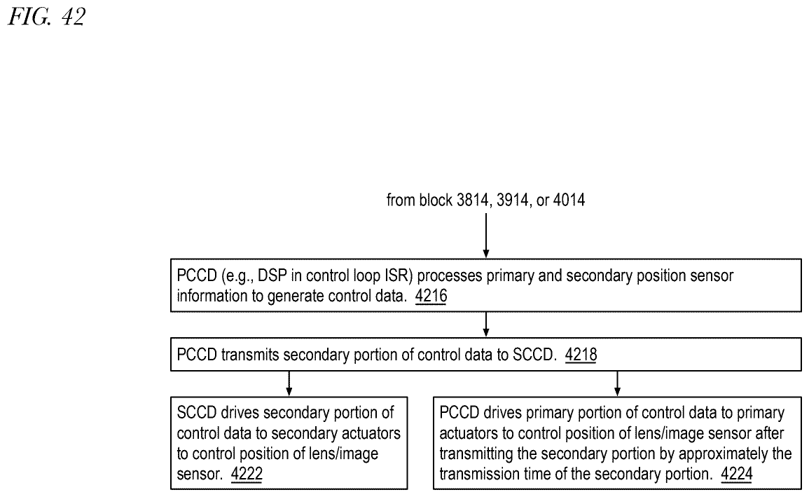

FIG. 41 is an example block diagram illustrating a system 4100 configured to perform unsynchronized on-demand remote sensing and remote actuation in accordance with the third embodiment of the present disclosure. In the system 4100 of FIG. 41, the SCCD 107 also includes output drivers 143 (unlike the SCCD 107 of the system 3700 of FIG. 37) that drive a secondary portion of the control data generated by the PCCD 105 to the actuators 131. In the embodiment of FIG. 41, the SCCD 107 includes two output drivers 143 denoted output driver 4 and output driver 5. However, other embodiments are contemplated in which the number of output drivers 143 of the SCCD 107 is different than two. The output drivers 143 of the SCCD 107 facilitate remote actuation, e.g., as described with respect to FIG. 42.

FIG. 42 is an example flowchart illustrating remote activation with respect to a system (e.g., system 4100 of FIG. 41) in accordance with the embodiments of the present disclosure. Operation proceeds to block 4216 of FIG. 42 from any of blocks 3814, 3914, or 4014 of FIG. 38A, FIG. 39A, or FIG. 40A.

At block 4216, the PCCD (e.g., a control loop ISR running on the DSP of the PCCD) processes the primary and secondary position sensor information (e.g., performs mathematical control loop computations on the position sensor information) to generate control data. A primary portion of the control data generated at block 4216 is for the PCCD to drive to the actuators and a secondary portion is for the SCCD to drive to the actuators. Operation proceeds to block 4218.

At block 4218, the PCCD transmits the secondary portion of the control data to the SCCD over the communication link. Operation proceeds concurrently to blocks 4222 and 4224.

At block 4222, the SCCD receives the secondary portion of the control data and drives it to the secondary actuators (e.g., via output driver 4 and output driver 5 of FIG. 41) to control the position of the lens/image sensor.

At block 4224, the PCCD drives the primary portion of the control data to the primary actuators (e.g., via output driver 1, output driver 2, and output driver 3 of FIG. 41) to control the position of the lens/image sensor. More specifically, after transmitting the secondary portion of the control data at block 4218, the PCCD delays approximately the transmission time of the secondary portion of the control data over the communication link before driving the primary portion of the control in order to minimize the primary-secondary output skew.

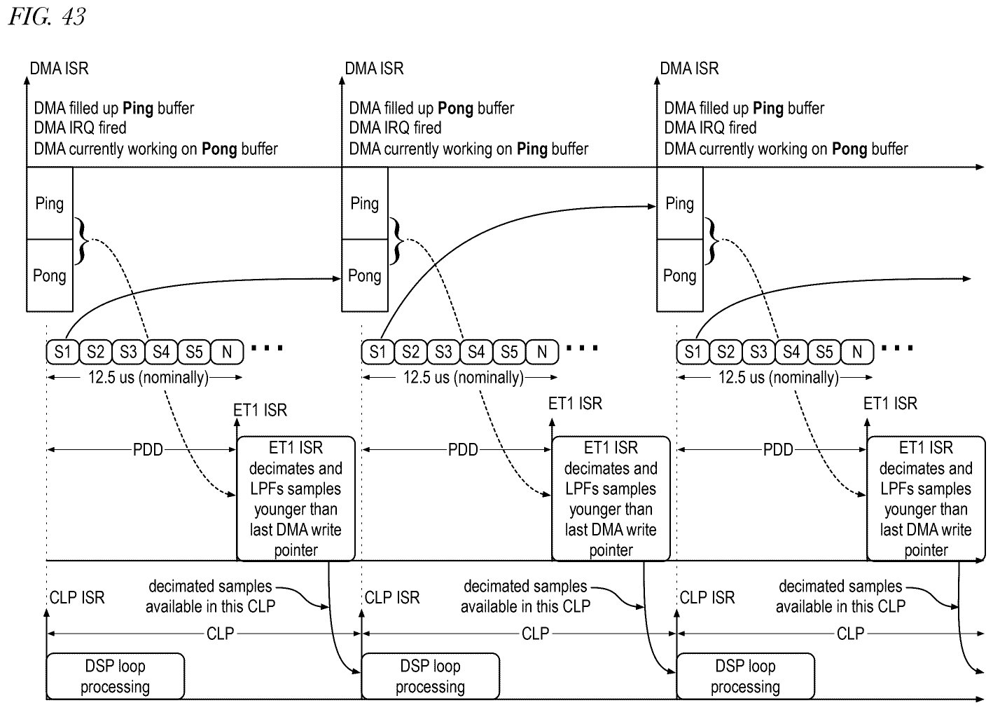

FIG. 43 is an example flow diagram illustrating use of the ping-pong buffers in accordance with the first embodiment of the present disclosure. FIG. 43 illustrates a sequence of three DMA ISR instances invoked by three corresponding DMA IRQs (not shown), a sequence of three CLP ISR instances invoked by three corresponding CLP IRQs (not shown), and a sequence of three ET1 ISRs invoked by three corresponding ET1 IRQs (not shown). FIG. 43 also illustrates three CLPs and three corresponding sequences of N primary position samples denoted S1, S2, S3, S4, S5, and N sampled during the corresponding CLP. In the example of FIG. 43, the sample period is nominally 12.5 microseconds such that N is 8 with a CLP of 100 microseconds, and N is 5 with a CLP of 62.5 microseconds for examples.

During each DMA ISR instance, the primary DSP manages descriptors of the ping-pong buffers for use by the primary DMAC to direct the DMAC to transfer the next N primary position samples to either the Ping buffer or to the Pong buffer in an alternating fashion (e.g., as described with respect to block 3804 of FIG. 38A). As shown in the example of FIG. 43, the DMAC performs DMA transfers to fill up the Ping buffer with N primary position samples taken during the previous CLP (not shown) and then fires a first DMA IRQ. In response to the first DMA IRQ, the first DMA ISR instance updates the buffer descriptors to direct the DMAC to perform DMA transfers to fill up the Pong buffer with the N primary position samples taken during the first CLP, i.e., the DMAC is working on filling the Pong buffer during the first CLP and generates the second DMA IRQ when finished. In response to the second DMA IRQ, the second DMA ISR instance updates the buffer descriptors to direct the DMAC to perform DMA transfers to fill up the Ping buffer with the N primary position samples taken during the second CLP, i.e., the DMAC is working on filling the Ping buffer during the second CLP and generates the third DMA IRQ when finished. In response to the third DMA IRQ, the third DMA ISR instance updates the buffer descriptors to direct the DMAC to perform DMA transfers to fill up the Pong buffer with the N primary position samples taken during the third CLP, i.e., the DMAC is working on filling the Pong buffer during the third CLP and generates a fourth DMA IRQ (also not shown) when finished.

During each ET1 ISR instance (which occurs a PDD after the CLP ISR as shown in FIG. 43), the primary DSP decimates and low-pass filters the primary samples that span the Ping and Pong buffers that are younger than the last DMA write pointer, i.e., that are youngest with respect to the ET1 IRQ (e.g., as described with respect to block 3814 of FIG. 38A and as shown in FIG. 38B), such that the decimated and LPF samples are available within the current CLP for the DSP loop processing in the next CLP (e.g., as described with respect to block 3816 of FIG. 38A). In the example of FIG. 43, of the N primary samples decimated by the ET1 ISR during the first and third CLPs, the youngest of the N samples are in the Pong buffer and the oldest of the N samples are in the Ping buffer; whereas, during the second CLP, the youngest of the N samples are in the Ping buffer and the oldest of the N samples are in the Pong buffer.

During each CLP ISR instance, the primary DSP performs the loop processing of the primary position sensor information that was decimated and low-pass filtered by the ET1 ISR in the previous CLP (and the secondary position sensor information received from the SCCD, not shown, in the previous CLP) to generate the control data (e.g., per blocks 3816 of FIG. 38A and as shown in FIG. 38B).

Although FIG. 43 describes use of the ping-pong buffers with respect to the PCCD, the SCCD may operate similarly to periodically transfer the secondary position samples in its ping-pong buffers and decimate and LPF the youngest secondary position samples with respect to reception of the demand packet.

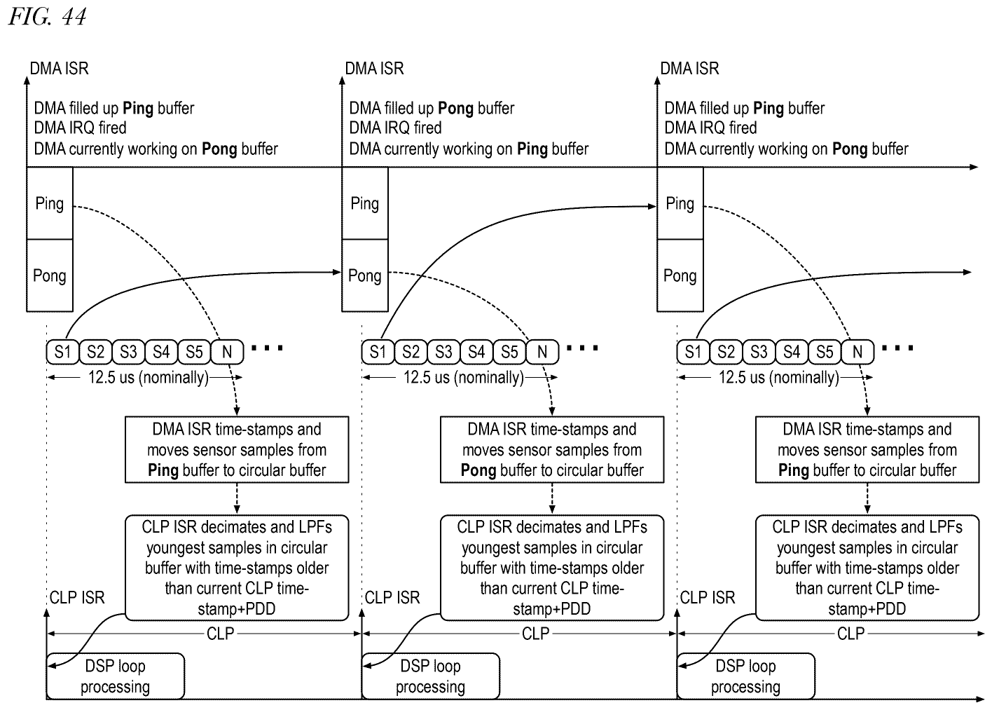

FIG. 44 is an example flow diagram illustrating use of the ping-pong buffers in accordance with the second embodiment of the present disclosure. FIG. 44 illustrates a sequence of three DMA TSR instances invoked by three corresponding DMA TRQs (not shown), a sequence of three CLP ISR instances invoked by three corresponding CLP IRQs (not shown), three CLPs and three corresponding sequences of N primary position samples denoted S1, S2, S3, S4, S5, and N sampled during the corresponding CLP, similar in many respects to those of FIG. 43. However, additionally, the first DMA ISR instance of FIG. 44 time-stamps the primary samples in the Ping buffer and moves them to a larger circular buffer, the second DMA ISR instance of FIG. 44 time-stamps the primary samples in the Pong buffer and moves them to the circular buffer, and the third DMA ISR instance of FIG. 44 time-stamps the primary samples in the Ping buffer and moves them to the circular buffer. Furthermore, during each instance of the CLP ISR, prior to performing the loop processing of the primary and secondary position sensor information to generate the control data (e.g., at block 3916 of FIG. 39A and as shown in FIG. 39B), the primary DSP decimates and low-pass filters the youngest primary samples in the circular buffer whose time-stamps are older than the time-stamp of the current CLP plus the PDD (e.g., at block 3914 of FIG. 39A and as shown in FIG. 39B).

FIG. 45 is an example block diagram of a secondary demand packet in accordance with the third embodiment of the present disclosure. The secondary demand packet is a single byte and includes an odd parity bit (PAR), a SYNC bit that is set to a zero value to indicate the byte is the last byte of the message, a 5-bit packet counter that counts from zero to 0x1F and resets, and a PSYNC bit that is normally set to zero value but may be set to a value of one if the PCCD desires to force the SCCD to resync to the value in the packet counter.

FIG. 46 is an example block diagram of a secondary position sensor information packet in accordance with the third embodiment of the present disclosure. The secondary position sensor information packet is a seven-byte packet, each byte having an odd parity bit (PAR) and a SYNC bit. In the first six bytes, the SYNC bit has a value of one, and in the seventh/last byte, the SYNC bit has a value of zero to indicate the last byte of the message. Bytes 1, 2 and half of byte 3 hold the 15-bit decimated and low-pass filtered secondary position information for sensor 1, and the other half of byte 3 and bytes 4 and 5 hold the 15-bit decimated and low-pass filtered secondary position information for sensor 2. Byte 6 includes a PS2_ACK bit that the SCCD sets to a value of one if the SCCD received a good secondary demand packet from the PCCD and that the SCCD sets to a value of zero if the SCCD received a bad secondary demand packet from the PCCD. Byte 6 also includes a PACKET_SEQERR bit that the SCCD sets to a value of one if the SCCD packet count and the packet counter value in the last received secondary demand packet from the PCCD do not match and that the SCCD sets to a value of zero in the case of a match. Byte 6 also includes a WATCHDOG_EXP_ERR bit, a TEMP_SHUTDOWN_ERR bit, an OPEN_LOOP_READY bit, and an ANALOG_READY bit. Byte 7 includes three reserved bits, a REMAINING_WARN bit, an AHB_BUS_WARN bit, and a DIG_OVER_TEMP_WARN bit.

Advantageously, the secondary position sensor information packet of FIG. 46 (as well as the secondary demand packet of FIG. 45) provides for SYNC-terminated messages to minimize the transmit delay over the communication link and to improve time-alignments, e.g., reduce control loop latency. The message format involves embedding the SYNC bit as follows. As described above, the SYNC bit is set to a value of one in all non-last bytes of the packet, and the SYNC bit is set to a value of zero in the last byte of the packet. This is because a zero-valued bit is marginally less susceptible to be received incorrectly due to a glitch. Furthermore, an escape is highly unlikely as it would have to simultaneously escape both the parity protection and the length checks. Other embodiments are contemplated in which the SYNC comprises more than one bit. The following pseudocode fragment illustrates the message reception algorithm.

```
// #define N to be the max understood message length.
// The message buffer must be N bytes long.
bytes_in_message buffer = 0
OnByteReceived ( new_byte ):
  if ( !parityOK ( new_byte ): // Bad parity
    bytes_in_message_buffer = 0 // Clear message buffer
  else: // Good parity
    if ( bytes_in_message_buffer < N ): // Add byte to buffer if there's space
                                  // (message buffer is of length N)
      Append new_byte to Message Buffer
      bytes_in_message_buffer++
      if ( ( 0 == SYNC Bit) && (N == bytes_in_message_buffer)): // Sync occurred
                                // (message ended) at expected length
        Message received, process message // Success!
        bytes_in_message_buffer = 0 // Clear message buffer on complete message
                                // (success)
    if ( ( 0 == SYNC Bit) && (0 != bytes_in_message_buffer)): // Unexpected
                                                      // message end
      bytes_in_message_buffer = 0 // Clear message buffer on complete message
                              // (error)
```

Although embodiments are described with a single secondary CCD, embodiments are contemplated in which the system includes multiple secondary CCDs and the communication link accommodates multiple secondary CCDs (e.g., another secondary CCD) to further increase the number of sensor channels of the system for remote sensing. In such a multiple-secondary remote sensing system, the age difference between samples decimated by the primary CCD and the secondary CCD may be further increased relative to a single-secondary system by approximately the transmission time of an additional demand packet and by the transmission time of an additional sensor position information packet. In an embodiment in which the communication link protocol provides for a broadcast packet that may be employed as a single demand packet to all the secondary CCDs, the additional demand packet transmission time may be avoided. Conversely, in such a multiple-secondary system, remote actuation may also be performed to further increase the number of control channels for remote actuation.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element.

Further embodiments, likewise, with the benefit of this disclosure, will be apparent to those having ordinary skill in the art, and such embodiments should be deemed as being encompassed herein.

For example, communication of (synchronized) updates between primary device and secondary device may be through a variety of communication types, such as full-duplex communication or half-duplex communication. Such communication may support robustness of data transport, additional configurations, additional sensors and/or additional processing on the secondary device and the communicating by the secondary device of such information that at least includes the health of the secondary device and/or other status or information relevant to the primary device.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

Finally, software can cause or configure the function, fabrication and/or description of the apparatus and methods described herein. This can be accomplished using general programming languages (e.g., C, C++), hardware description languages (HDL) including Verilog HDL, VHDL, and so on, or other available programs. Such software can be disposed in any known non-transitory computer-readable medium, such as magnetic tape, semiconductor, magnetic disk, or optical disc (e.g., CD-ROM, DVD-ROM, etc.), a network, wire line or another communications medium, having instructions stored thereon that are capable of causing or configuring the apparatus and methods described herein.

1. A system that controls the position of a lens/image sensor, comprising:
a primary camera control device (CCD);
a secondary CCD; and
a communication link that connects the primary CCD and the secondary CCD;
wherein the primary and secondary CCDs are configured to periodically sense respective primary and secondary position sensors to obtain respective primary and secondary position samples;
wherein the primary CCD is configured to:
prepare a demand for secondary position sensor information from the secondary CCD; and
transmit the demand to the secondary CCD over the communication link;
wherein the secondary CCD is configured to:
produce the secondary position sensor information by decimating secondary position samples that are youngest with respect to the demand; and
transmit the secondary position sensor information to the primary CCD over the communication link;
wherein the primary CCD is further configured to:
produce primary position sensor information by decimating primary position samples; and
generate control data by processing the primary and secondary position sensor information; and
wherein the primary CCD is configured to prepare the demand at a predetermined time offset from a start of a current control loop period such that the secondary position sensor information is received by the primary CCD within the current control loop period.

2. The system of claim 1,
wherein the time offset is predetermined to be approximately and no more than a difference of a control loop period and a sum of:
a first predetermined time to prepare the demand;
a second predetermined time to transmit the demand to the secondary CCD over the communication link;
a third predetermined time from the secondary CCD receiving the demand to beginning to transmit the secondary position sensor information over the communication link; and
a fourth predetermined time to transmit the secondary position sensor information to the primary CCD over the communication link.

3. The system of claim 2,
wherein the first and second times are predetermined based on a clock source of the primary CCD; and
wherein the third and fourth times are predetermined based on a worst-case frequency difference of clock sources of the primary and secondary CCDs.

4. The system of claim 2,
wherein even though clock sources of the primary and secondary CCDs are unsynchronized, an age difference between the decimated primary and secondary position samples is no greater than the control loop period.

5. The system of claim 2,
wherein even though clock sources of the primary and secondary CCDs are unsynchronized, an age difference between the decimated primary and secondary position samples is no greater than a sum of:
the third predetermined time;
the fourth predetermined time; and
a largest of:
a position sensor sample period of the primary CCD; and
a position sensor sample period of the secondary CCD.

6. The system of claim 1,
wherein the primary CCD is further configured to start a timer at the beginning of each control loop period; and
wherein the primary CCD is configured to prepare the demand in response to expiration of the timer.

7. The system of claim 1,
wherein the primary CCD is configured to perform the decimating the primary position samples during the current control loop period.

8. The system of claim 7,
wherein the primary position samples decimated by the primary CCD are youngest primary position samples with respect to a beginning of a next control loop period of the primary CCD.

9. The system of claim 1,
wherein the primary CCD is configured to perform the decimating the primary position samples during a next control loop period of the primary CCD.

10. The system of claim 1,
wherein even though clock sources of the primary and secondary CCDs are unsynchronized, an age difference between the decimated primary and secondary position samples is no greater than a largest of:
a position sensor sample period of the primary CCD; and
a position sensor sample period of the secondary CCD.

11. The system of claim 10,
wherein the primary CCD is further configured to start a timer at the beginning of each control loop period; and
wherein the primary position samples decimated by the primary CCD are youngest primary position samples with respect to expiration of the timer.

12. The system of claim 10,
wherein the primary CCD is further configured to assign a time-stamp to each of the periodically sensed primary position samples;
wherein the primary position samples decimated by the primary CCD are youngest primary position samples that have a time-stamp that is older than a second predetermined time offset from the start of the current control loop period.

13. The system of claim 10,
wherein each time the primary CCD senses the primary position sensors to obtain another primary position sample, the primary CCD is configured to:
produce a current primary position sensor information instance by decimating the youngest primary position samples; and
assign a time-stamp to the current primary position sensor information instance;
wherein the primary position sensor information processed by the primary CCD is the youngest current primary position sensor information instance that has a time-stamp that is older than a second predetermined time offset from the start of the current control loop period.

14. The system of claim 1,
wherein each time the secondary CCD senses the secondary position sensors to obtain another secondary position sample, the secondary CCD is configured to:
produce a current secondary position sensor information instance by decimating the youngest secondary position samples; and
assign a time-stamp to the current secondary position sensor information instance;
wherein the secondary position sensor information processed by the secondary CCD is the youngest current secondary position sensor information instance that has a time-stamp that is older than a second predetermined time offset from the start of the current control loop period.

15. The system of claim 1,
wherein the primary CCD is configurable to operate according to one of first and second modes;
wherein an age difference between the decimated primary and secondary position samples is smaller in the second mode relative to the first mode; and
wherein an age of the decimated primary position samples is younger in the first mode relative to the second mode.

16. The system of claim 1,
wherein clock sources of the primary and secondary CCDs are unsynchronized;
wherein the primary CCD is further configured to transmit a secondary portion of the control data over the communication link to the secondary CCD;
wherein the secondary CCD is further configured to apply the secondary portion of the control data in response to reception thereof; and
wherein the primary CCD is further configured to apply a primary portion of the control data.

17. The system of claim 16,
wherein the primary CCD waits to apply the primary portion of the control data until after a predetermined time to transmit the secondary portion of the control data over the communication link to the secondary CCD.

18. The system of claim 1,
wherein the demand and the secondary position sensor information are transmitted over the communication link in packets that include an embedded packet with one or more terminator bits; and
wherein the secondary CCD is further configured to:
read a received packet until a packet-terminating condition is detected;
in response to detecting the packet-terminating condition, evaluate the received packet for integrity errors; and
as each byte of the received packet is received, if a parity error is detected in the byte, discard the received packet and set a status bit.

19. A method for operating a system that controls the position of a lens/image sensor, the system comprising a primary camera control device (CCD) and a secondary CCD connected by a communication link, comprising:
periodically sensing, by the primary and secondary CCDs, respective primary and secondary position sensors to obtain respective primary and secondary position samples;
preparing, by the primary CCD, a demand for secondary position sensor information from the secondary CCD;
transmitting, by the primary CCD, the demand to the secondary CCD over the communication link;
producing, by the secondary CCD, the secondary position sensor information by decimating secondary position samples that are youngest with respect to the demand;
transmitting, by the secondary CCD, the secondary position sensor information to the primary CCD over the communication link;
producing, by the primary CCD, primary position sensor information by decimating primary position samples; and
generating, by the primary CCD, control data by processing the primary and secondary position sensor information;
wherein the primary CCD prepares the demand at a predetermined time offset from a start of a current control loop period such that the secondary position sensor information is received by the primary CCD within the current control loop period.

20. The method of claim 19,
wherein the time offset is predetermined to be approximately and no more than a difference of a control loop period and a sum of:
a first predetermined time to prepare the demand;
a second predetermined time to transmit the demand to the secondary CCD over the communication link;
a third predetermined time from the secondary CCD receiving the demand to beginning to transmit the secondary position sensor information over the communication link; and
a fourth predetermined time to transmit the secondary position sensor information to the primary CCD over the communication link.

21. The method of claim 20,
wherein the first and second times are predetermined based on a clock source of the primary CCD; and
wherein the third and fourth times are predetermined based on a worst-case frequency difference of clock sources of the primary and secondary CCDs.

22. The method of claim 20,
wherein even though clock sources of the primary and secondary CCDs are unsynchronized, an age difference between the decimated primary and secondary position samples is no greater than the control loop period.

23. The method of claim 20,
wherein even though clock sources of the primary and secondary CCDs are unsynchronized, an age difference between the decimated primary and secondary position samples is no greater than a sum of:
the third predetermined time;
the fourth predetermined time; and
a largest of:
a position sensor sample period of the primary CCD; and
a position sensor sample period of the secondary CCD.

24. The method of claim 19, further comprising:
starting, by the primary CCD, a timer at the beginning of each control loop period; and
preparing, by the primary CCD, the demand in response to expiration of the timer.

25. The method of claim 19,
wherein the primary CCD performs the decimating the primary position samples during the current control loop period.

26. The method of claim 25,
wherein the primary position samples decimated by the primary CCD are youngest primary position samples with respect to a beginning of a next control loop period of the primary CCD.

27. The method of claim 19,
wherein the primary CCD performs the decimating the primary position samples during a next control loop period of the primary CCD.

28. The method of claim 19,
wherein even though clock sources of the primary and secondary CCDs are unsynchronized, an age difference between the decimated primary and secondary position samples is no greater than a largest of:
a position sensor sample period of the primary CCD; and
a position sensor sample period of the secondary CCD.

29. The method of claim 28, further comprising:
starting, by the primary CCD, a timer at the beginning of each control loop period;
wherein the primary position samples decimated by the primary CCD are youngest primary position samples with respect to expiration of the timer.

30. The method of claim 28, further comprising:
assigning, by the primary CCD, a time-stamp to each of the periodically sensed primary position samples;
wherein the primary position samples decimated by the primary CCD are youngest primary position samples that have a time-stamp that is older than a second predetermined time offset from the start of the current control loop period.

31. The method of claim 28, further comprising:
by the primary CCD each time the primary CCD senses the primary position sensors to obtain another primary position sample:
producing a current primary position sensor information instance by decimating the youngest primary position samples; and
assigning a time-stamp to the current primary position sensor information instance;
wherein the primary position sensor information processed by the primary CCD is the youngest current primary position sensor information instance that has a time-stamp that is older than a second predetermined time offset from the start of the current control loop period.

32. The method of claim 19, further comprising:
by the secondary CCD each time the secondary CCD senses the secondary position sensors to obtain another secondary position sample:
producing a current secondary position sensor information instance by decimating the youngest secondary position samples; and
assigning a time-stamp to the current secondary position sensor information instance;
wherein the secondary position sensor information processed by the secondary CCD is the youngest current secondary position sensor information instance that has a time-stamp that is older than a second predetermined time offset from the start of the current control loop period.

33. The method of claim 19,
wherein the primary CCD is configurable to operate according to one of first and second modes;
wherein an age difference between the decimated primary and secondary position samples is smaller in the second mode relative to the first mode; and
wherein an age of the decimated primary position samples is younger in the first mode relative to the second mode.

34. The method of claim 19, further comprising:
wherein clock sources of the primary and secondary CCDs are unsynchronized;
transmitting, by the primary CCD, a secondary portion of the control data over the communication link to the secondary CCD;
applying, by the secondary CCD, the secondary portion of the control data in response to reception thereof; and
applying, by the primary CCD a primary portion of the control data.

35. The method of claim 34, further comprising:
waiting, by the primary CCD, to apply the primary portion of the control data until after a predetermined time to transmit the secondary portion of the control data over the communication link to the secondary CCD.

36. The method of claim 19, further comprising:
wherein the demand and the secondary position sensor information are transmitted over the communication link in packets that include an embedded packet with one or more terminator bits;
by the secondary CCD:
reading a received packet until a packet-terminating condition is detected;
in response to detecting the packet-terminating condition, evaluating the received packet for integrity errors; and
as each byte of the received packet is received, if a parity error is detected in the byte, discarding the received packet and setting a status bit.
